(19) United States
(12) Patent Application Publication
(10) Pub. No.: US 2012/0046874 A1
(43) Pub. Date: Feb. 23, 2012

(54) CONSIDERATION OF EVIDENCE

(75) Inventors: Roberto Puch-Solis, Birmingham (GB); Lauren Rodgers, Birmingham (GB)

(73) Assignee: FORENSIC SCIENCE SERVICE LIMITED, BIRMINGHAM BUSINESS PARK Solihull (GB)

(21) Appl. No.: 13/263,134

(22) PCT Filed: Apr. 9, 2010
(86) PCT No.: PCT/GB10/00741

§ 371 Date: Oct. 6, 2011

(30) Foreign Application Priority Data
Apr. 9, 2009 (GB) 0906275.3
Apr. 16, 2009 (GB) 0906676.2

(51) Int. Cl. G06F 19/22

(52) U.S. Cl. 702/19

(57) ABSTRACT

A computer implemented method of comparing a test sample result set with another sample result set is provided, the method including: providing information for the first result set on the one or more identities detected for a variable characteristic of DNA; providing information for the second result set on the one or more identities detected for a variable characteristic of DNA; and comparing at least a part of the first result set with at least a part of the second result set; and wherein: the comparing includes a likelihood and the likelihood uses a probability density function conditioned on DNA quantity. Further benefits are obtained from the manner in which the probability density function is obtained and/or the use of probability density functions to account for stutter and/or allele dropout.

This invention concerns improvements in and relating to the consideration of evidence, particularly, but not exclusively the consideration of DNA evidence.

In many situations, particularly in forensic science, there is a need to consider one piece of evidence against one or more other pieces of evidence.

For instance, it may be desirable to compare a sample collected from a crime scene with a sample collected from a person, with a view to linking the two by comparing the characteristics of their DNA. This is an evidential consideration. The result may be used directly in criminal or civil legal proceedings. Such situations include instances where the sample from the crime scene is contributed to by more than one person.

In other instances, it may be desirable to establish the most likely matches between examples of characteristics of DNA samples stored on a database with a further sample. The most likely matches or links suggested may guide further investigations. This is an intelligence consideration.

In both of these instances, it is desirable to be able to express the strength or likelihood of the comparison made, a so called likelihood ratio.

The present invention has amongst its possible aims to establish likelihood ratios. The present invention has amongst its possible aims to provide a more accurate or robust method for establishing likelihood ratios. The present invention has amongst its possible aims to provide probability distribution functions for use in establishing likelihood ratios, where the probability distribution functions are derived from experimental data. The present invention has amongst its possible aims to provide for the above whilst taking into consideration stutter and/or dropout of alleles in DNA analysis

According to a first aspect of the invention we provide a method of comparing a test sample result set with another sample result set, the method including:
providing information for the first result set on the one or more identities detected for a variable characteristic of DNA;
providing information for the second result set on the one or more identities detected for a variable characteristic of DNA; and
comparing at least a part of the first result set with at least a part of the second result set.

The method of comparing may be used to considered evidence, for instance in civil or criminal legal proceedings. The comparison may be as to the relative likelihoods, for instance a likelihood ratio, of one hypothesis to another hypothesis. The comparison may be as to the relative likelihoods of the evidence relating to one hypothesis to another hypothesis. In particular, this may be a hypothesis advanced by the prosecution in the legal proceedings and another hypothesis advanced by the defence in the legal proceedings. The likelihood ratio may be of the form:

$$LR = \frac{p ( c , gs \vert {V}_{p} )}{p ( c , gs \vert {V}_{d} )} = \frac{f ( c \vert gs , {V}_{p} )}{f c \vert gs , {V}_{d} )}$$

where
c is the first or test result set from a test sample, more particularly, the first result set taken from a sample recovered from a person or location linked with a crime, potentially expressed in terms of peak positions and/or heights and/or areas;
gs is the second or another result set, more particularly, the second result set taken from a sample collected from a person, particularly expressed as a suspect's genotype;
Vₚ is one hypothesis, more particularly the prosecution hypothesis in legal proceedings stating “The suspect left the sample at the scene of crime”;
V_{d} is an alternative hypothesis, more particularly the defence hypothesis in legal proceedings stating “Someone else left the sample at the crime scene”.

The method may include a likelihood which includes a factor accounting for stutter. The factor may be included in the numerator and/or the denominator of a likelihood ratio, LR. The method may include a likelihood which includes a factor accounting for allele dropout. The factor may be included in the numerator and/or denominator of an LR.

The method may include an LR which includes a factor accounting for stutter in both numerator and denominator. The method may include an LR which includes a factor accounting for allele dropout in both numerator and denominator.

Stutter may occur where, during the PCR amplification process, the DNA repeats slip out of register. A stutter sequence may be one repeat length less in size than the main sequence. Dropout may occur where a sequence present in the sample is not reflected in the results for the sample after analysis.

The method may include an estimated PDF for homozygote peaks conditional on DNA quantity.

The method may include an estimated PDF for stutter heights conditional on the height of the parent allele.

The method may include an estimated joint probability density function (PDF) of peak height pairs conditional on DNA quantity

The method may include a latent variable X representing DNA quantity that models the variability of peak heights across the profile.

The method may include a latent variable Δ that discounts DNA quantity according to a numerical representation of the molecular weight of the locus and/or models DNA degradation.

The method may include a step including an LR. The LR may summarise the value of the evidence in providing support to a pair of competing propositions: one of them representing the view of the prosecution (Vₚ) and the other the view of the defence (V_{d}). The propositions may be:
1) Vₚ: The suspect is the donor of the DNA in the crime stain;
2) V_{d}: Someone else is the donor of the DNA in the crime stain.

The crime profile c in a case may consist of a set of crime profiles, where each member of the set is the crime profile of a particular locus. Similarly, the suspect genotype gₛ may be a set where each member is the genotype of the suspect for a particular locus. The crime profile may be stated as: c={c_{L(i)}:i=,2, . . . , n_{Loci}} where n_{Loci} is the number of loci in the profile. The suspect genotype may be stated as: gs={gs,_{L(i)}:=1,2, . . . , n_{Loci}}, where n_{Loci} is the number of loci in the profile.

The definition of the numerator may be or include: Lₚ=f(c|gₛ,Vₚ).

The definition of the numerator may be rendered independent between loci. The likelihood Lₚ may be factorised conditional on DNA quantity χ. The definition of the numerator may be or include: Lₚ=f(cₕ|gₛ,h,χ,Vₚ). The definition of the numerator may be or include, for a three locus consideration:

Lₚ=f(c_{L(1)},c_{L(2)},c_{L(3)},|g_{s,L(1)},g_{s,L(2)},g_{s,L(3)},Vₚ).

The definition of the numerator may be or include:

Lₚ=f(c_{L(1)}|g_{s,L(1)},χᵢ,Vₚ)×f(c_{L(2)}|g_{s,L(2)},χᵢ,Vₚ)×f(c_{L(3)}|g_{s,L(3)},χᵢ,Vₚ).

The definition of the numerator may be or include:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

The definition of the numerator may be or include, where L_{p,L(j)}(χᵢ) is the likelihood for locus j conditional on DNA quantity:

L_{p,L(j)}(χ)=f(c_{L(j)}|g_{s,L(j)},Vₚ,χⱼ)

or:

L_{p,L(j)}(χ)=f(c_{L(j)}|gₕ₍ⱼ₎,V,χⱼ)

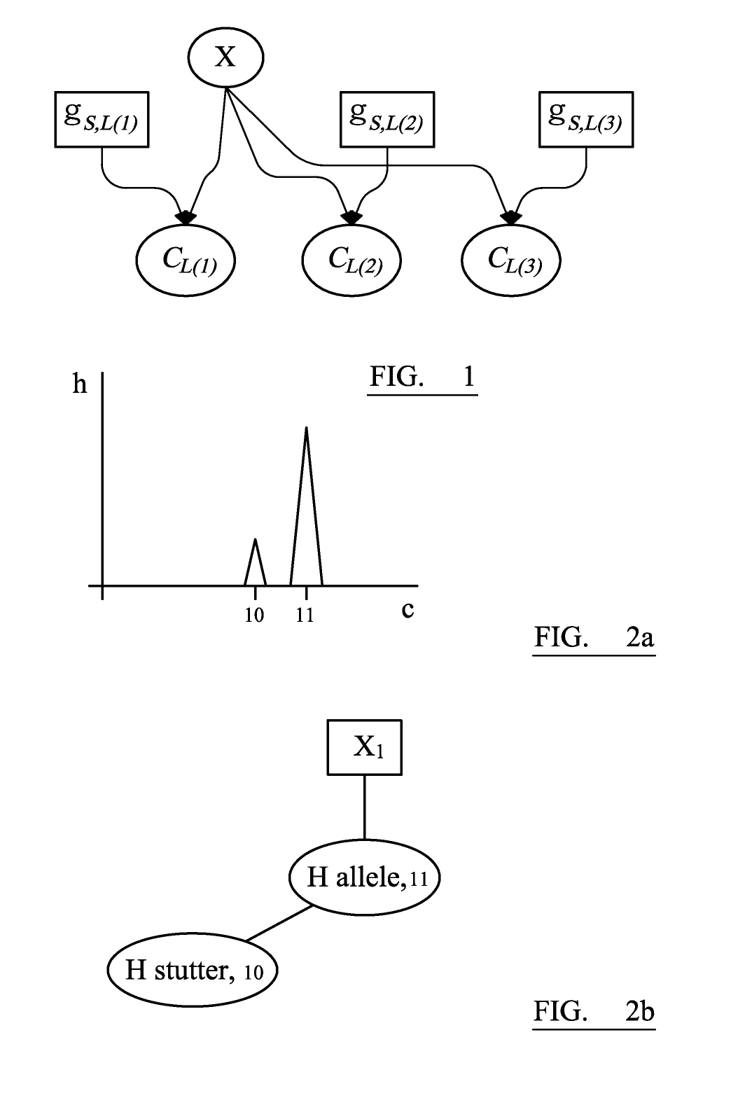

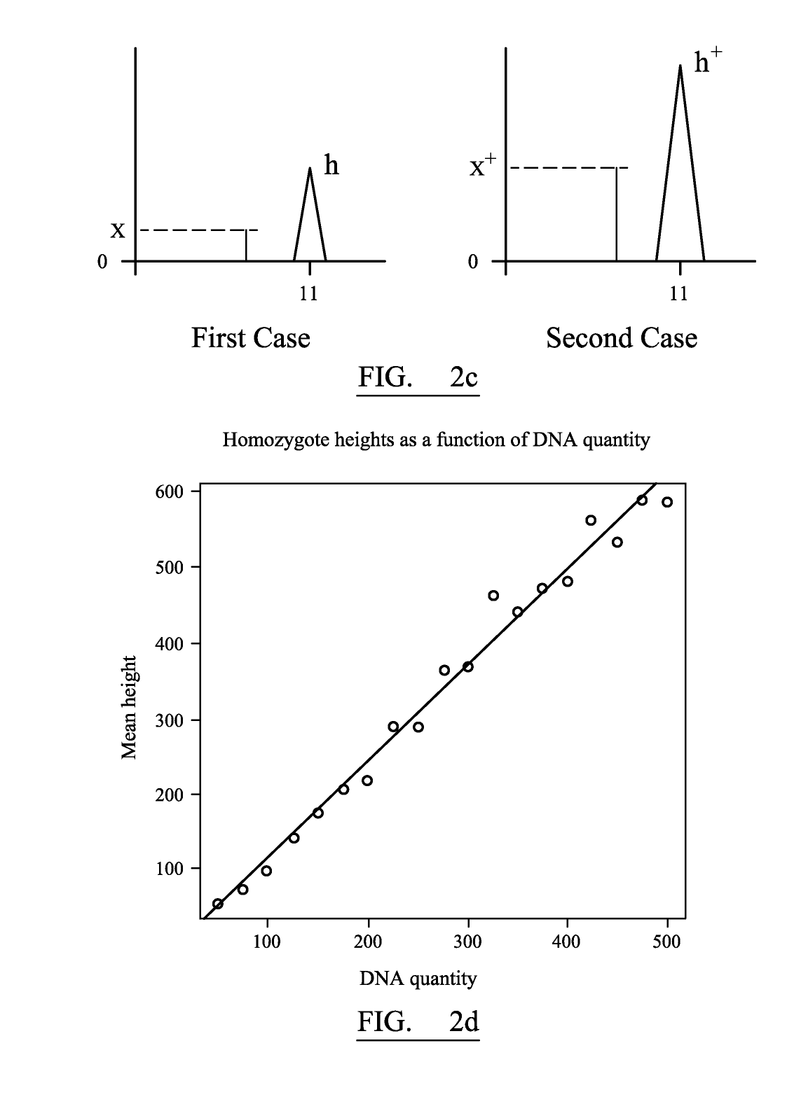

The definition of the numerator may be or include: quantities, probabilistic quantities and probabilistic dependencies of the form of the Bayesian Network illustrated in FIG. 1.

The definition of the numerator may be or include, where the crime profile C_{L(i)} is conditionally independent of C_{L(j)} given DNA quantity X for i≠j,i,j ∈ {1,2, . . . , n_{L}}:

C_{L(1)} [symbol] C_{Lj|}X.

The definition of the numerator may be or include, where a discrete probability distribution on DNA quantity is used as an approximation to a continuous probability distribution, that the discrete probability distribution is written as {Pr(χ=_{χ}_{ⁱ}): i=1, 2, . . . , nₓ} or can be written as {p(χᵢ): i=1,2, . . . , n_{χ}}.

The definition of the numerator may be or include that the likelihood in L_{p,L(j)}(χ)=f(c_{L(j)|}g_{s,L(j)},Vₚ,X) specified a likelihood of the heights in the crime profile given the genotype of a putative donor.

The definition of the numerator may be or include: L_{L(j)}(χ)=f(c_{L(j)|}g_{L(j)}),V,χ), where V states that the genotype of the donor of crime profile c_{L(i)} is g_{L(j)}.

The definition of the numerator may be or include:

$${\sum }_{{χ}_{i}} [ {\prod }_{j}^{n loci} f ( {c}_{h ( j )} \vert {g}_{s , L ( j )} , {V}_{p} , {χ}_{i} ) ] p ( {χ}_{i} )$$

where the consideration is in effect, the genotype (gₛ) is the donor of (cₕ₍ⱼ₎) given the DNA quantity (χᵢ).

The calculations for the LR may be divided into three categories. The three categories may apply to the numerator and/or to the denominator. The genotype of the profile's donor may be either:
1) a heterozygote with adjacent alleles; or
2) a heterozygote with non-adjacent alleles; or
3) a homozygote.

Where the genotype of the profile's donor is homozygous, the features of the following first embodiment may particularly apply.

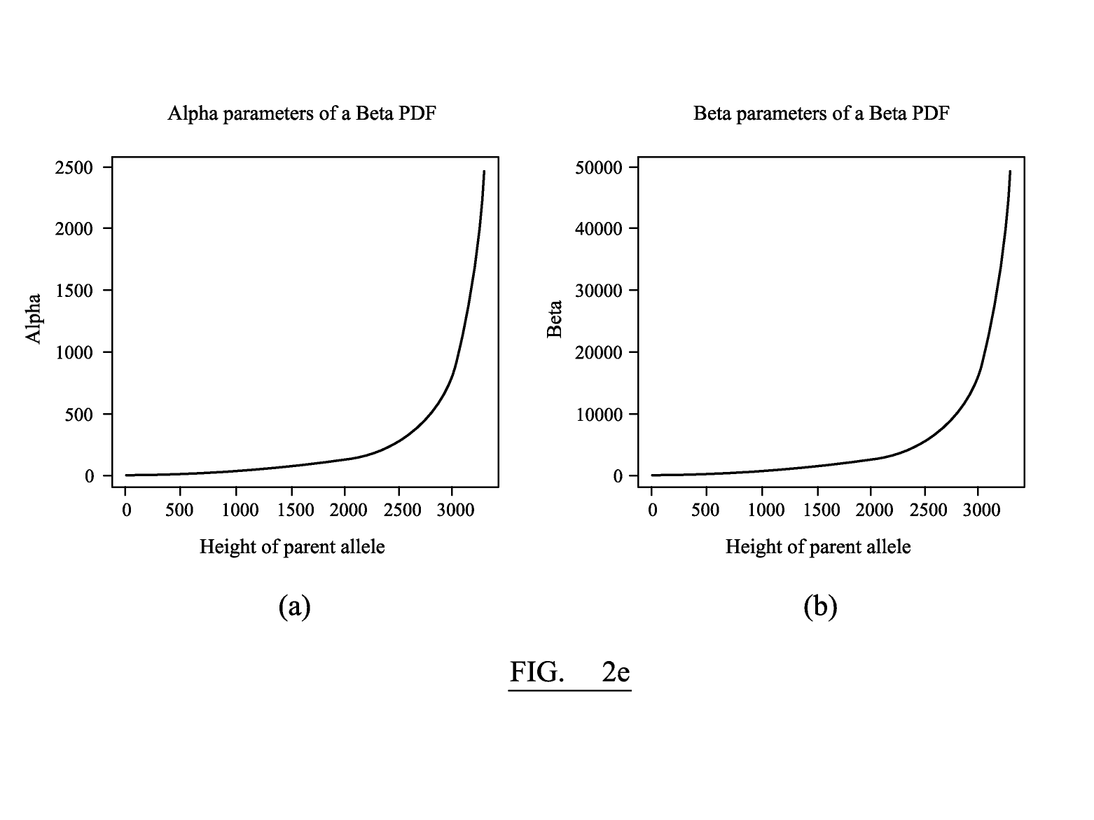

The first embodiment may include that the definition of the numerator may be or include: quantities, probabilistic quantities and probabilistic dependencies of the form of the Bayesian Network illustrated in FIG. 2b.

The first embodiment may include a definition in which the stutter peak height for an allele is dependent upon the allele peak height for the allele which is one size unit greater. A probability distribution function may be provided for the variation of the stutter peak height for an allele with the allele peak height for the allele which is one size unit greater The first embodiment may include a definition in which the allele peak height for the allele may be dependent upon the DNA quantity, χ. A probability distribution function may be provided for the variation of the allele peak height for the allele with DNA quantity.

The probability distribution function for the variation of the allele peak height for the allele with DNA quantity may be obtained from experimental data, for instance by measuring allele peak height for a large number of different, but known DNA quantities. The probability distribution function may be modeled by a Gamma distribution. The Gamma distribution may be specified through two parameters: preferably the shape parameter α and the rate parameter β. These parameters may be further specified through two parameters: preferably the mean height h̅, which models the mean value of the homozygote peaks, and parameter k that models the variability of peak heights for the given DNA quantity χ. The mean value h̅ may be calculated through a linear relationship between mean heights and DNA quantity. The variance may be modeled with a factor k which is set to 10. The parameters α and β of the Gamma distribution may be:

α= h̅/k and β=α/ h̅

The probability distribution function for the variation of the stutter peak height for an allele with the allele peak height for the allele which is one size unit greater may be obtained from experimental data, for instance by measuring the stutter peak height for a large number of different, but known DNA quantity samples, with the source known to be homozygous. These results can be obtained from the same experiments as provide the allele peak height information mentioned in the previous paragraph. The probability distribution function may provide a Beta distribution describing the probabilistic behaviour of the stutter height from the allele height. The generic formula for the Beta distribution may be:

$$f ( y \vert α , β ) = \frac{Γ ( α + β )}{Γ ( α ) Γ ( β )} {{y}^{α - 1} ( 1 - y )}^{β - 1}$$

The conditional PDF f_{H}_{ₛ}|_{H} may be specified through the parameters of the Beta distribution that models stutter proportions, that is, stutter height divided by parent allele height. More specifically it may be:

$${f}_{{H}_{s}} {\vert}_{H} ( {h}_{s} \vert h ) = \frac{1}{h} \times f {π}_{s} {\vert}_{H} ( {π}_{s} \vert α ( h ) , β ( h ) )$$

where α(h) and β(h) are the parameters of a Beta PDF.

The method may include a PDF for allele height for all loci, but preferably with a separate PDF for allele height for each locus considered. A separate PDF for each allele at each locus is also possible. The methodology can be applies with a PDF for stutter height for all loci, but preferably with a separate PDF for stutter height at each locus considered. A separate PDF for each allele at each locus is also possible.

The method may include a probability distribution function of formula:

f_{L(j)}(hₛₜᵤₜₜₑᵣ,hₐₗₗₑₗₑ)=fₛ(hₛₜᵤₜₜₑᵣ|hₐₗₗₑₗₑ)fₕₒₘ(hₐₗₗₑₗₑ).

Where the genotype of the profile's donor is heterozygous with non-adjacent alleles, then the features of the following embodiment may particularly apply.

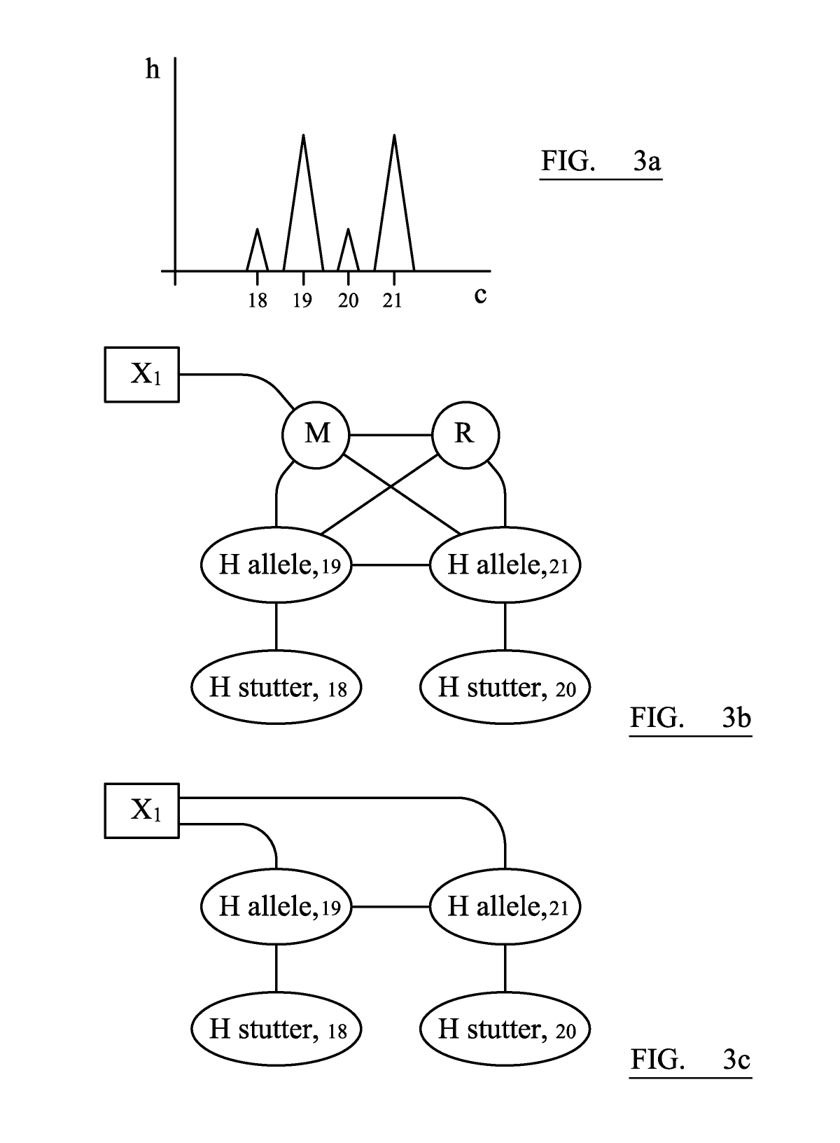

The second embodiment may include a definition of the numerator which may be or include: quantities, probabilistic quantities and probabilistic dependencies of the form of the Bayesian Network illustrated in FIG. 3b.

The second embodiment may include a definition in which the stutter peak height for an allele is dependent upon the allele peak height for an allele which is one size unit greater. This may apply to one such pairs of alleles or to both such pairs of alleles. The allele peak height for an allele, preferably in both pairs, may be dependent upon the DNA quantity.

The second embodiment may provide that the DNA quantity is assumed to be a known quantity.

The second embodiment may include providing a probability distribution function which represents the variation in height of the stutter peak with variation in height of the allele peak. Such a probability distribution may be provided for both stutter peaks. The second embodiment may provide a probability distribution function which represents the variation in height of the allele peak with variation in DNA quantity. Such a probability distribution may be provided for both allele peaks.

The probability distribution function may be the same probability distribution function as for the first embodiment, particularly where the same locus is being considered.

The probability distribution function for the variation of the allele peak height for the allele with DNA quantity may be obtained from experimental data, for instance by measuring allele peak height for a large number of different, but known DNA quantities.

The probability distribution function for the variation of the stutter peak height for an allele with the allele peak height for the allele which is one size unit greater may be obtained from experimental data, for instance by measuring the stutter peak height for a large number of different, but known DNA quantity samples, with the source known to be homozygous. These results can be obtained from the same experiments as provide the allele peak height information mentioned in the previous paragraph.

The second embodiment may include providing a probability distribution function which represents the variation in both the allele peak height for one allele and for the allele peak height for the other allele dependent upon the heterozygous imbalance and the mean peak height. The second embodiment may include providing a probability distribution function which represents the variation in heterozygous imbalance and the mean peak eight with DNA quantity.

The heterozygous imbalance may be defined as:

$$r = \frac{{h}_{allele 1}}{{h}_{allele 2}}$$

The mean height is defined as:

$$m = \frac{{h}_{allele 1} + {h}_{allele 2}}{2}$$

The probability distribution function for f(hₐₗₗₑₗₑ₁,hₐₗₗₑₗₑ₂) may be defined as:

f(hₐₗₗₑₗₑ₁,hₐₗₗₑₗₑ₂)=|J|.f(r|m).f(m)

with the heterozygous imbalance, r, potentially having a probability distribution function of the log normal form, ideally for each value of m, so as to give a family of log normal probability distribution functions overall; and preferably with the mean, m, having a probability distribution function of gamma form, for each value of χ, with a series of discrete values for χ being considered.

The second embodiment may provide that the specification of a joint distribution of pairs of peak heights h₁ and h₂ is described. The specification may be done by the specification of a joint distribution of mean height m and heterozygote imbalance, which is given by:

$$( {h}_{1} , {h}_{2} ) ↦ ( m = \frac{{h}_{1} + {h}_{2}}{2} , r = \frac{{h}_{1}}{{h}_{2}} )$$

The second embodiment may provide the specification of a joint probability distribution function for mean height M and heterozygote imbalance R to provide a joint probability distribution function for peak heights H₁ and H₂ using the formula:

$${f}_{H 1} {,}_{H 2} ( {h}_{1} , {h}_{2} \vert χ ) = \frac{1}{{h}_{2}^{2}} ( \frac{{h}_{1} + {h}_{2}}{2} ) \times {f}_{M , R} ( m , r \vert χ )$$

The second embodiment may provide the specification of a joint probability distribution of M and R through the marginal distribution of M, f_{M}(m|χ), and the conditional distribution of R given m, f_{R}|_{M}(r|m). The joint probability distribution function for heights may be given by the formula:

$${f}_{H 1} {,}_{H 2} ( {h}_{1} , {h}_{2} \vert χ ) = \frac{1}{{h}_{2}^{2}} ( \frac{{h}_{1} + {h}_{2}}{2} ) \times {f}_{R , M} ( r \vert m ) {f}_{M} ( m \vert χ )$$

The second embodiment may provide for the specification of the probability distribution function for M and/or for R|M=m.

The second embodiment may provide that the probability distribution function f_{M}(m|χ) represents a family of probability distribution functions for mean height, one for each value of DNA quantity. The probability distribution function may be a Gamma probability distribution function, preferably of formula:

$$f ( x α , β ) = \frac{1}{{s}^{α} Γ ( α )} {x}^{α - 1} {e}^{- x / s}$$

where s=1/β. The parameter α is preferably the shape parameter, β is preferably the rate parameter and s is preferably the scale parameter. The specification of the Gamma probability distribution function may be achieved through the specification of the parameter α and β parameters as a function of DNA quantity χ. The specification may be provided through two intermediary parameters m̅ and k that model the mean value and the variance of M, respectively. The mean of the Gamma distributions may be given by a linear function

From the parameters m̅ and k, the parameters of α and β of a Gamma distribution can be computed using the formula: α= m̅|k, β=α/ m̅.

The second embodiment may provide that the conditional PDFs of heterozygote imbalance are modeled with log normal PDFs, particularly whose PDF is given by:

$${f}_{R} ( r \vert μ , σ ) = \frac{1}{r \times σ ( m ) \sqrt{2 π}} {exp}^{\frac{- {( ln ( r ) - μ )}^{2}}{2 σ ( m )}}$$

The Log normal PDF may be fully specified through parameters μ and σ(m).

The definition of the numerator may be or include: quantities, probabilistic quantities and probabilistic dependencies of the form of the Bayesian Network illustrated in FIG. 3c.

The probability distribution function may be or include the formula:

f_{L(j)}(hₛₜᵤₜₜₑᵣ₁,hₐₗₗₑₗₑ₁,hₛₜᵤₜₜₑᵣ₂,hₐₗₗₑₗₑ₂)=fₛₜᵤₜₜₑᵣ(hₛₜᵤₜₜₑᵣ₁|hₐₗₗₑₗₑ₁)fₛₜᵤₜₜₑᵣ(hₛₜᵤₜₜₑᵣ₂|hₐₗₗₑₗₑ₂)fₕₑₜ(hₐₗₗₑₗₑ₁|hₐₗₗₑₗₑ₂)

Where the genotype of the profile's donor is heterozygous with adjacent alleles, then the features of the following embodiment may particularly apply.

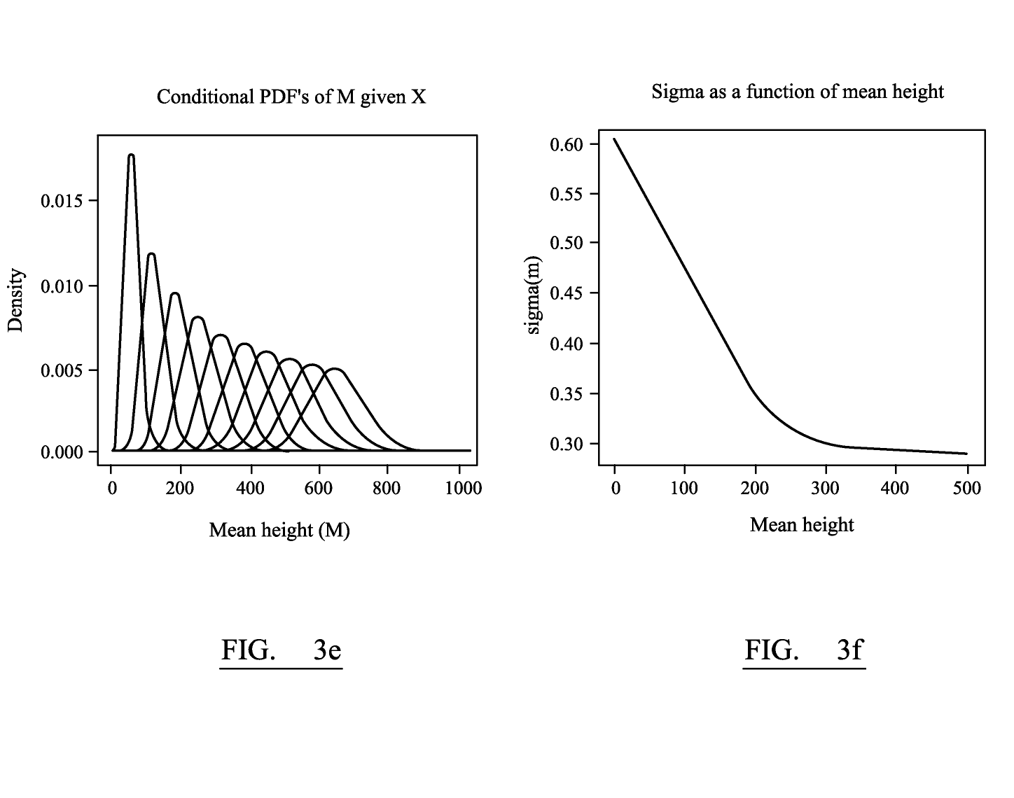

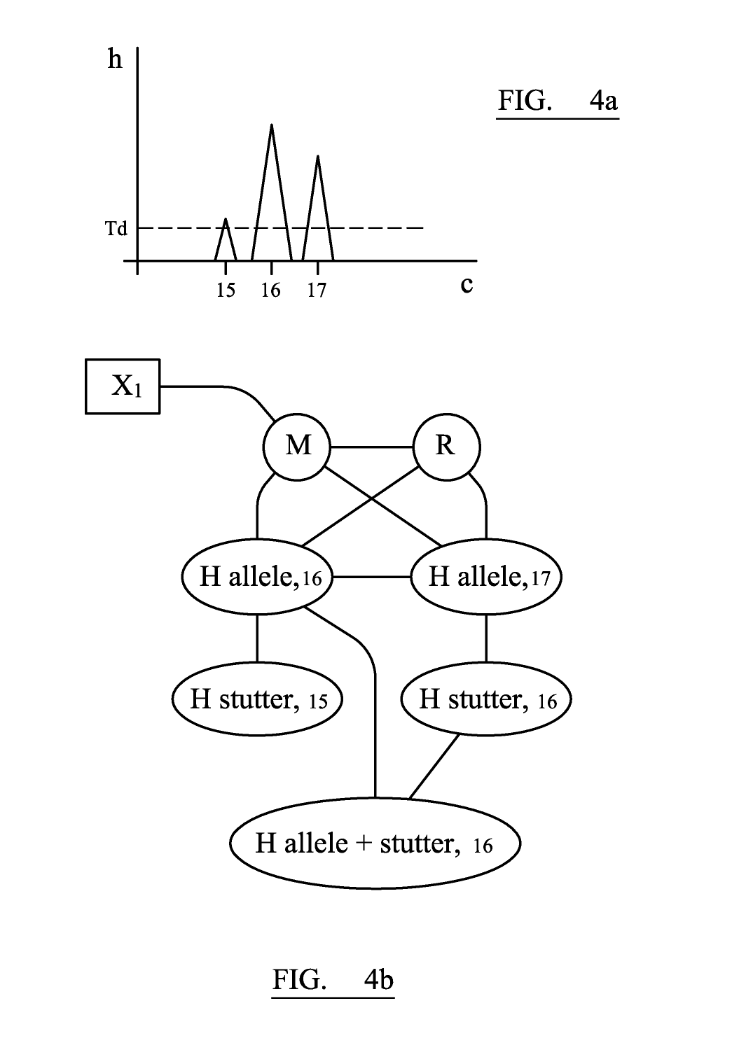

In the third embodiment, the definition of the numerator may be or include: quantities, probabilistic quantities and probabilistic dependencies of the form of the Bayesian Network illustrated in FIG. 4b.

The third embodiment may include providing probability distribution functions which represent the variation in the stutter peak height for an allele which is dependent upon the allele peak height for an allele one size unit greater. A probability distribution function may be provided to represent the variation of the peak height of the allele which is in turn dependent upon the DNA quantity. A probability distribution function may be provided to represent the variation of the second stutter peak height for an allele which is dependent upon the allele peak height for an allele one size unit greater than the second stutter. A probability distribution function may be provided to represent the variation of the allele peak height for an allele one size unit greater than the second stutter which is in turn dependent upon the DNA quantity. A probability distribution function may be provided to represent the variation of the combined allele and stutter peak at an allele which is dependent upon the allele peak height for the allele of that size unit and is dependent upon the stutter peak height for that allele size unit.

The observed results in the profile may include the peak height for the first stutter, the peak height for the second allele and the peak height for the first allele and the second stutter combined. The results for the peak height of the second stutter and the first allele may not be separately observed results in the profile.

A probability distribution function may be provided to represent the variation of both the allele peak height for the first allele and the allele peak height for the second allele dependent upon the heterozygous imbalance, R and the mean peak height, M. A probability distribution function may be provided to represent the variation of the heterozygous imbalance, R and the mean peak height, M upon the DNA quantity.

The third embodiment may include a definition of the probability distribution function for allele+stutter peak height with allele peak height and stutter peak height, for instance as: f(hₐₗₗₑₗₑ₁₋ₛₜᵤₜₜₑᵣ₁|hₐₗₗₑₗₑ₁,hₛₜᵤₜₜₑᵣ₁)=1 if hₐₗₗₑₗₑ₁₌ₛₜᵤₜₜₑᵣ₁=hₐₗₗₑₗₑ₁+hₛₜᵤₜₜₑᵣ₁ and has value=0 otherwise.

The third embodiment may include a definition of the probability distribution function for the other two observed dependents by integrating out the variation with the first allele and stutter of the first allele. The third embodiment may include a definition of a probability distribution function of the form:

f(hₐₗₗₑₗₑ₁₆,hₐₗₗₑₗₑ₁₇|χ)×f(hₛₜᵤₜₜₑᵣ₁₅|hₐₗₗₑₗₑ₁₆)×f(hₛₜᵤₜₜₑᵣ₁₆|hₐₗₗₑₗₑ₁₇)×f(hₐₗₗₑₗₑ₊ₛₜᵤₜₜₑᵣ₁₆|hₐₗₗₑₗₑ₁₆,hₛₜᵤₜₜₑᵣ₁₆)

and/or of the form:

f(hₐₗₗₑₗₑ₁₆,hₐₗₗₑₗₑ₁₇|χ)×f(hₛₜᵤₜₜₑᵣ₁₅,hₐₗₗₑₗₑ₁₆,hₛₜᵤₜₜₑᵣ₁₆,hₐₗₗₑₗₑ₊ₛₜᵤₜₜₑᵣ₁₆,hₐₗₗₑₗₑ₁₇)

The definition of the numerator may be or include: quantities, probabilistic quantities and probabilistic dependencies of the form of the Bayesian Network illustrated in FIG. 4c.

The numerator may be or include the definition: L_{L(1)}(χ)=f(c_{L(1)}|g_{L(1)},V,χ).

The third embodiment may include a definition of a probability distribution function of the form:

f_{L(1)}(h₁₅,h₁₆,h₁₇)=∫_{R}fₛ(h₁₅|h_{a,16})fₛ(h_{s,16}|h₁₇)fₕₑₜ(h_{a,16},h₁₇)dh_{a,16}dh_{s,16}

where R={hₐ₁₆,h_{s,16}:h_{a,16}+h_{s,16}=h₁₆}; fₛ is a PDF for stutter heights conditional on parent height; and fₕₑₜ is a PDF of pairs of heights of heterozygous genotypes. The PDFs in these sections may be provided for any value hᵢ, including hᵢ less than the threshold T_{d}.

The integral in the equation above can be computed by numerical integration or Monte Carlo integration. The preferred method for numerical integration is adaptive quadratures. The simplest method which may be provided is integration by hitogram approximation.

The integral in the previous equation can be approximated with the summation:

$${f}_{L ( 1 )} ( {h}_{15} , {h}_{16} , {h}_{17} ) \approx {\sum }_{{h}_{a , 16} = {h}_{15} + 1}^{{h}_{16}} {f}_{s} ( {h}_{15} \vert {h}_{a , 16} ) {f}_{s} ( {h}_{s , 16} \vert {h}_{17} ) {f}_{het} ( {h}_{a , 16} , {h}_{17} )$$

where h_{s,16}=h₁₆−h_{a,16}. The step in the summation may be one or a larger increment, for instance x_{inc}, may be provided.

The first embodiment may include a definition in which the formula f_{L(j)}(hₛₜᵤₜₜₑᵣ,hₐₗₗₑₗₑ) gives density values for any positive value of the arguments. The method may consider occasions where either technical dropout or dropout has occurred. The method may include one or more integrations. The form of the integrations may be determined by the case, particularly of one or more allele heights relative to a limit of detection threshold. The method may provide for three possible cases in the first embodiment.

One possible case may be where hₛₜᵤₜₜₑᵣ≧T_{d},hₐₗₗₑₗₑ≧T_{d} then the numerator may be given by: L_{L(j)}(χ)=f_{L(j)}(hₛₜᵤₜₜₑᵣ,hₐₗₗₑₗₑ).

A further possible case may be where hₛₜᵤₜₜₑᵣ [symbol] (T_{d},hₐₗₗₑₗₑ≧T_{d} then the method may include performing one integral and/or the numerator may be given by:

$${L}_{L ( j )} ( χ ) \approx {\sum }_{{h}_{stutter} = 1}^{{T}_{d}} {f}_{L ( j )} ( {h}_{stutter} , {h}_{allele} )$$

A still further possible case may be where hₛₜᵤₜₜₑᵣ [symbol] (T_{d},hₐₗₗₑₗₑ [symbol] T_{d} then the numerator may be given by:

$${L}_{L ( j )} ( χ ) \approx {\sum }_{{h}_{stutter} = 1}^{{T}_{d}} {\sum }_{{h}_{allele} = {h}_{stutter} + 1}^{{T}_{d}} {f}_{L ( j )} ( {h}_{stutter} , {h}_{allele} )$$

The second embodiment may include a definition in which the formula f_{L(j)}(hₛₜᵤₜₜₑᵣ₁,hₐₗₗₑₗₑ₁,hₛₜᵤₜₜₑᵣ₂,hₐₗₗₑₗₑ₂), gives density values for any positive value of the arguments. The method may consider occasions where either technical dropout, where a peak is smaller than the limit-of-detection threshold T_{d}, or dropout, where a peak is in the baseline, have occurred. The method may include performing one or more integrations. The form of the integrations may be determined by the case, particularly of one or more allele heights relative to a limit of detection threshold. The method may provide for eight possible cases in the second embodiment.

One possible case may be where hₛₜᵤₜₜₑᵣ₁≧T_{d},hₐₗₗₑₗₑ₁≧T_{d},hₛₜᵤₜₜₑᵣ₂≧T_{d},hₐₗₗₑₗₑ₂≧T_{d}, in which case L_{L(j)}(χ)=f_{L(j)}(hₛₜᵤₜₜₑᵣ₁,hₐₗₗₑₗₑ₁,hₛₜᵤₜₜₑᵣ₂,hₐₗₗₑₗₑ₂).

In a second case, hₛₜᵤₜₜₑᵣ₁≧T_{d},hₐₗₗₑₗₑ₁≧T_{d},hₛₜᵤₜₜₑᵣ₂ [symbol] T_{d},hₐₗₗₑₗₑ₂ [symbol] T_{d}, two integrations are computed, to preferably give:

$${L}_{L ( j )} ( χ ) \approx {\sum }_{{h}_{stuttere 2} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 1} , {h}_{stutter 2} , {h}_{allele 2} )$$

In a third case, hₛₜᵤₜₜₑᵣ₁ [symbol] T_{d},hₐₗₗₑₗₑ₁≧T_{d},hₛₜᵤₜₜₑᵣ₂≧T_{d},hₐₗₗₑₗₑ₂≧T_{d}, one integration is computed, to preferably give:

$${L}_{L ( j )} ( χ ) \approx {\sum }_{{h}_{stutter 1} = 1}^{{T}_{d}} {f}_{L ( j )} ( {h}_{stutter 1} , {h}_{allele 1} , {h}_{stutter 2} , {h}_{allele 2} )$$

In a fourth case, hₛₜᵤₜₜₑᵣ₁ [symbol] T_{d},hₐₗₗₑₗₑ₁≧T_{d},hₛₜᵤₜₜₑᵣ₂ [symbol] T_{d},hₐₗₗₑₗₑ₂≧T_{d}, two integrations are computed, preferably to give:

$${L}_{L ( j )} ( χ ) \approx {\sum }_{{h}_{stutter 1} = 1}^{{T}_{d}} {\sum }_{{h}_{stutter 2} = 1}^{{T}_{d}} {f}_{L ( j )} ( {h}_{stutter 1} , {h}_{allele 1} , {h}_{stutter 2} , {h}_{allele 2} )$$

In a fifth case, hₛₜᵤₜₜₑᵣ₁ [symbol] T_{d},hₐₗₗₑₗₑ₁≧T_{d},hₛₜᵤₜₜₑᵣ₂ [symbol] T_{d},hₐₗₗₑₗₑ₂ [symbol] T_{d}, three integrations are computed, preferably to give:

$${L}_{L ( j )} ( χ ) \approx {\sum }_{{h}_{stutter 1} = 1}^{{T}_{d}} {\sum }_{{h}_{stutter 2} = 1}^{{T}_{d}} {\sum }_{{h}_{stutter 2} + 1}^{{T}_{d}} {f}_{L ( j )} ( {h}_{stutter 1} , {h}_{allele 1} , {h}_{stutter 2} , {h}_{allele 2} )$$

In a sixth case, hₛₜᵤₜₜₑᵣ₁ [symbol] T_{d},hₐₗₗₑₗₑ₁ [symbol] T_{d},hₛₜᵤₜₜₑᵣ₂≧T_{d},hₐₗₗₑₗₑ₂≧T_{d}, two integrations are computed, preferably to give:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {f}_{L ( j )} ( {h}_{stutter 1} , {h}_{allele 1} , {h}_{stutter 2} , {h}_{allele 2} )$$

In a seventh case, hₛₜᵤₜₜₑᵣ₁ [symbol] T_{d},hₐₗₗₑₗₑ₁ [symbol] T_{d},hₛₜᵤₜₜₑᵣ₂ [symbol] T_{d},hₐₗₗₑₗₑ₂≧T_{d}, three integrations are computed, preferably to give:

$${L}_{L ( j )} ( χ ) \approx {\sum }_{{h}_{stutter 1} = 0}^{{T}_{d}} {\sum }_{{h}_{allele 1} = {h}_{stutter 1} + 1}^{{T}_{d}} {\sum }_{{h}_{stutter 2} = 0}^{{T}_{d}} {f}_{L ( j )} ( {h}_{stutter 1} , {h}_{allele 1} , {h}_{stutter 2} , {h}_{allele 2} )$$

In an eighth case, hₛₜᵤₜₜₑᵣ₁ [symbol] T_{d},hₐₗₗₑₗₑ₁ [symbol] T_{d},hₛₜᵤₜₜₑᵣ₂ [symbol] T_{d},hₐₗₗₑₗₑ₂ [symbol] T_{d}, four integrations are computed to give:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {\sum }_{{h}_{stutter 2} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 1} , {h}_{stutter 2} , {h}_{allele 2} )$$

The third embodiment may include a definition in which the formula f_{L(1)}(h₁₅,h₁₆,h₁₇) provides density values for each value of the arguments. The method may include occasions where technical dropout has occurred, that is, a peak is smaller than the limit-of-detection threshold T_{d}. The method may include the calculation of further integrals to obtain the required likelihoods. The form of the integrations may be determined by the case, particularly of one or more allele heights relative to a limit of detection threshold. The method may provide for six possible cases in the second embodiment.

The integrals of the third embodiment may be computed by numerical integration or Monte Carlo integration.

In a first case, hₛₜᵤₜₜₑᵣ₁≧T_{d},hₐₗₗₑₗₑ₁₊ₛₜᵤₜₜₑᵣ₂≧T_{d},hₐₗₗₑₗₑ₂≧T_{d}, then the numerator of the LR for this locus may be given by:

L_{L(j)}(χ)=f_{L(j)}(hₛₜᵤₜₜₑᵣ₁,hₐₗₗₑₗₑ₁₊ₛₜᵤₜₜₑᵣ₂,hₐₗₗₑₗₑ₂)

In a second case, hₛₜᵤₜₜₑᵣ₁ [symbol] T_{d},hₐₗₗₑₗₑ₁₊ₛₜᵤₜₜₑᵣ₂≧T_{d},hₐₗₗₑₗₑ₂≧T_{d}, an integration is needed, potentially of the form:

$${L}_{L ( j )} ( χ ) \approx {\sum }_{{h}_{stutter 1} = 1}^{{T}_{d}} {f}_{L ( j )} ( {h}_{stutter 1} , {h}_{allele 1 + stutter 2} , {h}_{allele 2} )$$

In a third case, hₛₜᵤₜₜₑᵣ₁ [symbol] T_{d},hₛₜᵤₜₜₑᵣ₂₊ₐₗₗₑₗₑ₁ [symbol] T_{d},hₐₗₗₑₗₑ₂≧T_{d}, two integrals are computed, potentially of the form:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {f}_{L ( j )} ( {h}_{stutter 1} , {h}_{allele 1 + stutter 2} , {h}_{stutter 2} ) d {h}_{stutter 1} d {h}_{allele 1 + stutter 2}$$

In a fourth case, hₛₜᵤₜₜₑᵣ₁ [symbol] T_{d},hₐₗₗₑₗₑ₁₊ₛₜᵤₜₜₑᵣ₂≧T_{d},hₐₗₗₑₗₑ₂ [symbol] T_{d}, two integrals are computed, potentially of the form:

$${L}_{L ( j )} ( χ ) \approx {\sum }_{{h}_{stutter 1} = 1}^{{T}_{d}} {\sum }_{{h}_{allele 2} = 1}^{{T}_{d}} {f}_{L ( j )} ( {h}_{stutter 1} , {h}_{allele 1 + stutter 2} , {h}_{stutter 2} )$$

In a fifth case, hₛₜᵤₜₜₑᵣ₁≧T_{d},hₐₗₗₑₗₑ₁₊ₛₜᵤₜₜₑᵣ₂≧T_{d},hₐₗₗₑₗₑ₂ [symbol] T_{d}, one integral is computed, potentially of the form:

$${L}_{L ( j )} ( χ ) \approx {\sum }_{{h}_{allele 2} = 1}^{{T}_{d}} {f}_{L ( j )} ( {h}_{stutter 1} , {h}_{allele 1 + stutter 2} , {h}_{stutter 2} )$$

In a sixth case, hₛₜᵤₜₜₑᵣ₁ [symbol] T_{d},hₐₗₗₑₗₑ₁₊ₛₜᵤₜₜₑᵣ₂ [symbol] T_{d},hₐₗₗₑₗₑ₂ [symbol] T_{d} three integrals are computed, potentially of the form:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {\sum }_{{h}_{allele 2}}^{{T}_{d}} {f}_{L ( j )} ( {h}_{stutter 1} , {h}_{allele 1 + stutter 2} , {h}_{stutter 2} )$$

The definition of the denominator may be or include: L_{d}=f(c|gₛ,V_{d}). The definition of the denominator may be or include, where the crime profile c extends across loci, for a three locus example: L_{d}=f(c_{L(1)},c_{L(2)},c_{L(3)}|g_{s,L(1)},g_{s,L(2)},g_{s,L(3)},V_{d}). The definition of the denominator may be or include the likelihood L_{d} factorised according to DNA quantity. The definition of the denominator may be or include, for a three locus example:

$${L}_{d} = {\sum }_{{χ}_{i}}^{ } f ( {c}_{L ( 1 )} \vert {g}_{L ( 1 )} , {V}_{d} , {χ}_{i} ) f ( {c}_{L ( 2 )} \vert {g}_{L ( 2 )} , {V}_{d} {χ}_{i} ) f ( {c}_{L ( 3 )} \vert {g}_{L ( 3 )} , {V}_{d} {χ}_{i} ) .$$

The definition of the denominator may be or include: f(c_{L(j)}|g_{L(j)},V_{d},χᵢ)

The definition of the denominator may be or include the expansion of the expression f(c_{L(j)}|g_{L(j)},V_{d},χᵢ), for instance as:

$$f ( {c}_{L ( j )} \vert {g}_{L ( j )} , {V}_{d} , {χ}_{i} ) = {\sum }_{{g}_{U , L ( j )}} f ( {c}_{L ( j )} {g}_{U , L ( j )} , {V}_{d} , χ \vert ) \times p ( {g}_{U , L ( j )} \vert {g}_{S , L ( j )} , {V}_{d} )$$

The first term on the right hand side of the definition

$$f ( {c}_{L ( j )} \vert {g}_{L ( j )} , {V}_{d} , {χ}_{i} ) = {\sum }_{{g}_{U , L ( j )}} f ( {c}_{L ( j )} {g}_{U , L ( j )} , {V}_{d} , χ \vert ) \times p ( {g}_{U , L ( j )} \vert {g}_{S , L ( j )} , {V}_{d} )$$

may correspond to a term of matching form found in the numerator, as discussed above and expressed as: L_{L(j)}(χ)=f(c_{L(j)|}g_{L(j)},V,χ). The second term in the right-hand side may be a conditional genotype probability. This can be computed using existing formula for conditional genotype probabilities given putative related and unrelated contributors with population structure or not, for instance using the approach defined in J. D. Balding and R. Nichols. DNA profile match probability calculation: How to allow for population stratification, relatedness, database selection and single bands. Forensic Science International, 64:125-140, 1994.

The definition of the denominator may be or include the expression: L_{d,L(j)}(χ)=f(c_{L(j)}|g_{U,L(j)},V_{d},χ), for instance, with the likelihood in this specified as a likelihood of the heights in the crime profile given the genotype of a putative donor, and potentially written as: L_{L(j)}(χ)=f(c_{L(j)}|g_{L(j)},V,χ), where V states that the genotype of the donor of crime profile c_{L(j)} is g_{L(j)}.

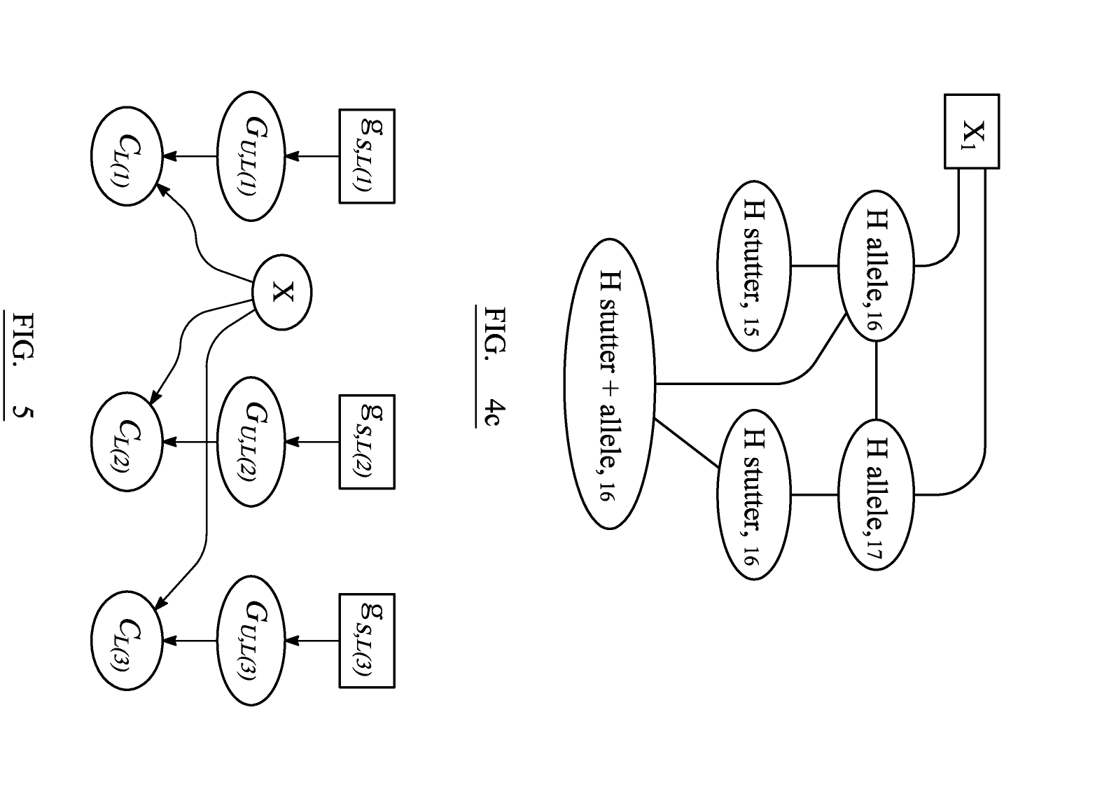

The definition of the denominator may be or include: quantities, probabilistic quantities and probabilistic dependencies in the form of the Bayesian Network illustrated in FIG. 5.

The definition of the denominator may be or include the expression:

$${\sum }_{{χ}_{i}} [ {\prod }_{j}^{n loci} \sum f ( {c}_{L ( j )} \vert {g}_{u , L ( j )} , {V}_{d} , {χ}_{i} ) \times p ( {g}_{u , L ( j )} \vert {g}_{s , L ( j )} ) ] p ( {χ}_{i} )$$

where the consideration is in effect, the genotype (gₛ) is the donor of (cₕ₍ⱼ₎) given the DNA quantity (χᵢ).

The definition of the denominator may be or include the calculation of the likelihood of observing a set of heights giving any potential contributors. The definition of the denominator may be or include a method for generating genotype of unknown contributors that will lead to a non-zero likelihood.

The various possible cases observed from a single unknown contributor may be considered, for instance to provide the definition of the denominator for the possible cases. The method may provide for seven possible cases.

In a first possible case, the observed profile at the locus may have four peaks. For this to be a single profile the method may provide two pair of heights where each pair are adjacent. If the heights are c_{L(i)}={h₁,h₂,h₃,h₄}, then the only possible genotype of the contributor may be g_{U}={2,4}. The method may provide that the crime profile c_{L(i)} remains unchanged.

In a second possible case, the observed profile at the locus may have three peaks with one allele not adjacent. For this to be a single profile, there may be two possible sub-cases to consider. A first possible sub-case may be that the larger two peaks are adjacent. If the peak heights are c_{L(i)}={h₂,h₅,h₆}, then the only possible genotype may be g_{U},_{L(i)}={2,6} and c_{L(i)}={h₁,h₂,h₅,h₆} where h₁=0. A second possible case may be that the smaller two peaks are adjacent. If the peak heights are {h₂,h₃,h₅}, the only possible genotype may be g_{U}={3,5} and c_{L(i)}={h₂,h₃,h₄,h₅} where h₄=0.

In a third possible case, the observed profile at the locus may have three adjacent peaks. For this to be a single profile, there may be tow possible sub-cases to consider. A first possible sub-case may be, where the allele heights are written as c_{L(i)}={h₂,h₃,h₄}, g_{U},_{L(i)}={2,4}. A second possible sub-case may be g_{U},_{L(i)}={3,4}. If g_{U},_{L(i)}={2,4}, then preferably c_{L(i)}={h₁,h₂,h₃,h₄} where h₁=0. If g_{U},_{L(i)}={3,4}, then preferably c_{L(i)} remains unchanged.

In a fourth possible case, the observed profile at the locus may have two non-adjacent peaks. If allele heights are c_{L(i)}={h₂,h₄}, then the only possible genotype may be g_{U},_{L(i)}={2,4} and c_{L(i)}={h₁,h₂,h₃,h₄} where h₁=0 and h3=0.

In a fifth possible case, the observed profile at the locus may have two adjacent peaks. If allele heights are c_{L(i)}={h₂,h₃} then four possible genotypes need to be considered: g_{U},_{L(i)}={2,3}, g_{U},_{L(i)}={3,3}, g_{U},_{L(i)}={3,4} or g_{U},_{L(i)}={3,Q} where Q is any other allele different than alleles 2, 3 and 4. If g_{U},_{L(i)}={2,3}, then preferably c_{L(i)}={h₁,h₂,h₃} where h₁=0. If g_{U},_{L(i)}={3,3}, then preferably c_{L(i)}={h₂,h₃} remains unchanged. If g_{U},_{L(i)}={3,4}, then preferably c_{L(i)}={h₂,h₃,h₄} where h₄=0. If g_{U},_{L(i)}={3,Q}, then preferably c_{L(i)}={h₂,h₃,h_{s,Q},h_{Q}} where h_{s,Q}=h_{Q}=0.

In a sixth possible case, the observed profile at the locus may have one peak. If the peak is denoted by c_{L(i)}={h₂}, then three possible genotypes may need to be considered: g_{U},_{L(i)}={2,2}, g_{U},_{L(i)}={2,3} or g_{U},_{L(i)}={2,Q}, where Q is any allele other than 2 and 3. If g_{U},_{L(i)}={2,2}, then preferably c_{L(i)}={h₁,h₂} where h₁=0. If g_{U},_{L(i)}={2,3}, then preferably c_{L(i)}={h₁,h₂,h₃} where h₁=h₃=0. If g_{U},_{L(i)}={2,Q}, then preferably c_{L(i)}={h₁,h₂,h_{s,Q},h_{Q}} where h₁=h_{s,Q}=h_{Q}=0.

In a seventh possible case, the observed profile at the locus may have no observed peak. If this case the LR may be one and therefore, there is no need to compute anything.

The method may be used in the comparison and/or for computing likelihood ratios for mixed profiles while considering peak heights and/or allelic dropout and/or stutters.

The method may include considering various hypotheses: The possible hypotheses may be or include:

Prosecution hypotheses, such as:
Vₚ(S+V): The DNA came from the suspect and the victim; and/or
Vₚ(S₁+S₂): The DNA came from suspect 1 and suspect 2; and/or
Vₚ(S+U): The DNA came from the suspect and an unknown contributor; and/or
Vₚ(V+U): The DNA came from the victim and an unknown contributor.

Defence hypotheses, such as:
V_{d}(S+U): The DNA came from the suspect and an unknown contributor; and/or
V_{d}(V+U): The DNA came from the victim and an unknown contributor; and/or
V_{d}(U+U): The DNA came from two unknown contributors.

The method may include the consideration of one or more combinations of hypotheses, for instance, the combinations may be or include:
Vₚ(S+V) and V_{d}(S+U); and/or
Vₚ(S+V) and V_{d}(V+U); and/or
Vₚ(S+U) and V_{d}(U+U); and/or
Vₚ(V+U) and V_{d}(U+U); and/or
Vₚ(S₁+S₂) and V_{d}(U+U).

The method may include denoting by K₁ and K₂ the person whose genotypes are known. The method may include or consist of three generic pairs of propositions, such as:
Vₚ(K₁+K₂) and V_{d}(K₁+U); and/or
Vₚ(K₁+U) and V_{d}(U+U); and/or
Vₚ(K₁+K₂) and V_{d}(U+U).

The method may consider the likelihood ratio (LR) is the ratio of the likelihood for the prosecution hypotheses to the likelihood for the defence hypotheses. The method may consider the LR's for the three generic combinations of prosecution and defence hypotheses, namely:
Vₚ(K₁+K₂) and V_{d}(K₁+U); and/or
Vₚ(K₁+U) and V_{d}(U+U); and/or
Vₚ(K₁+K₂) and V_{d}(U+U).

The method may include denoting p(w) as a discrete probability distribution for mixing proportion w and/or denoting p(x) as a discrete probability distribution for x.

In the case of combination Vₚ(K₁+K₂) and V_{d}(K₁+U), the numerator of the LR may be:

$$num = {\sum }_{x} {\sum }_{w} {\prod }_{i}^{n loci} f ( {C}_{L ( i )} \vert g 1 , L ( i ) , g 2 , {L}_{( i )} , w , x ) p ( w ) p ( x )$$

where:
g₁ and g₂ are the genotypes of the known contributors K₁ and K₂ across loci;
c. is the crime profile across loci;
the subscript L(i) means that the either the genotype of crime profile is for locus i or n_{loci} is the number of loci.

In the case of combination Vₚ(K₁+K₂) and V_{d}(K₁+U), the denominator of the LR may be:

$$den = {\sum }_{x} {\sum }_{w} {\prod }_{i}^{n loci} {\sum }_{gU , L ( i )} f ( {C}_{L ( i )} \vert {g}_{1} , L ( i ) , gU , L ( i ) , w , x ) p ( gU , L ( i ) \vert {g}_{1} , L ( i ) , {g}_{2} , L ( i ) ) p ( w ) p ( x )$$

where:
g1,L(i) is the genotype of the known contributor in locus I;
g2,L(i) is a known genotype for locus i but it is not proposed as a genotype of the donor of the mixture;
gU,L(i) is the genotype of the unknown donor.

The conditional genotype probability in the right-hand-side of the equation may be calculated using the Balding and Nichols model.

The function in the left-hand side equation may be calculated from probability distribution functions.

In the case of combination Vₚ(K₁+U) and V_{d}(U+U) the numerator may be:

$$num = {\sum }_{x} {\sum }_{w} {\prod }_{i}^{n loci} {\sum }_{gU , L ( i )} f ( {C}_{L ( i )} \vert {g}_{1} , {L}_{i} , gu , {L}_{( i )} , w , x ) p ( gu , L ( i ) \vert g 1 , L ( i ) ) p ( w ) p ( x )$$

where:
g1,L(i) is the genotype of the known contributor K₁ in locus i.

In the case of combination Vₚ(K₁+U) and V_{d}(U+U) the denominator may be:

$$den = {\sum }_{x} {\sum }_{w} {\prod }_{i}^{{n}_{Loci}} {\sum }_{{g}_{{U}_{1} , L ( i )} , {g}_{{U}_{2} , L ( i )}} f ( {C}_{L ( i )} \vert {g}_{{U}_{1} , L ( i )} , {g}_{{U}_{2} , L ( i )} , w , x ) p ( {g}_{{U}_{1} , L ( i )} , {g}_{{U}_{2} , L ( i )} \vert {g}_{1 , L ( i )} , {g}_{2} , L ( i ) ) p ( w ) p ( x )$$

where:
g1,L(i) is the genotype of the known contributor K₁ in locus i; and
g_{U1},L(i) and g_{U2},L(i) are the genotypes for locus i of the unknown contributors.

The second factor may be computed as:

p(g_{U}_{₁}_{,Λ(i)},g_{U}_{₂}_{,Λ(i)}|g_{1,Λ(i)})=p(g_{U}_{₁}_{,Λ(i)}|g_{1,Λ(i)},g_{U}_{₂}_{,Λ(i)})p(g_{U}_{₂}_{,Λ(i)}|g_{1,Λ(i)})

The factors in the right-hand-side of the equation may be computed using the model of Balding and Nichols.

In the case of combination Vₚ(K₁+K₂) and V_{d}(U+U), the numerator may be the same as the numerator for the first generic pair of hypotheses.

In the case of combination Vₚ(K₁+K₂) and V_{d}(U+U), the denominator may be:

$$den = {\sum }_{x} {\sum }_{w} {\prod }_{i}^{{n}_{Loci}} {\sum }_{{g}_{{U}_{1} , Λ ( i )} , {g}_{{U}_{2} , Λ ( i )}} f ( {c}_{Λ ( i )} \vert {g}_{{U}_{1} , Λ ( i )} , {g}_{{U}_{2} , Λ ( i )} , w , x ) p ( {g}_{{U}_{1} , Λ ( i )} , {g}_{{U}_{2} , Λ ( i )} \vert {g}_{1 , Λ ( i )} , {g}_{2 , Λ ( i )} ) p ( w ) p ( x )$$

where:
g1,L(i) and g2,L(i) are the genotypes of the known contributors K₁ and K₂ in locus i;
gU₁,L(i) and gU₂,L(i) are the genotypes for locus i of the unknown contributors.

The second factor may be computed as:

p(g_{U}_{₁}_{,Λ(i)},g_{U}_{₂}_{,Λ(i)}|g_{1,Λ(i)},g_{2,Λ(i)})=p(g_{U}_{₁}_{,Λ(i)}|g_{1,Λ(i)},g_{2,Λ(i)},g_{U}_{₂}_{,Λ(i)})p(g_{U}_{₂}_{,Λ(i)}|g_{1,Λ(i)},g_{2,Λ(i)})

The factors in the right-hand-side of the equation may be computed using the model of Balding and Nichols.

The method may include the use of per locus conditional genotype probabilities and/or density values of per locus crime profiles given putative per locus genotypes of two contributors. The conditional genotype probabilities may be calculated using the model of Balding and Nichols.

The density values of per locus crime profiles may be defined by: f(cL(i)|g1,L(i),g2,L(i),w,x). The method may include the use of the function f(cL(i)|g1,L(i),g2,L(i),w,x).

The method may use the approach of the following embodiment, where the allele numbers are used to denote different allele positions, with a higher number reflecting a higher size of allele relative to the others.

The method may consider a situation where the genotypes and crime profiles are defined as:

g_{1,Λ(i)}={16,17}

g_{2,Λ(i)}={18,20}

c_{Λ(i)}={h*_{,15},h*_{,16},h*_{,17},h*_{,18},H*_{,19},h*_{,20}}.

The method may include obtaining an intermediate probability density function (PDF), particularly defined as the product of the factors:

f(h_{1,15},h_{1,16},h_{1,17}|g_{1,Λ(i)}={16,17},w×x) 1.

f(h_{2,17},h_{2,18},h_{2,19}|g_{2,Λ(i)}={18,28},(1−w)×x) 2.

δ_{S}(h₁₇|h_{1,17},h_{2,17}) 3.

The first factor may be defined as a PDF for a single contributor. The second factor may be defined as a PDF for a single contributor. The third factor may be a degenerated PDF defined by: δ_{S}(h₁₇|h_{1,17},h_{2,17})=1 if h₁₇=h_{1,17}+h_{2,17} and zero otherwise.

The intermediate PDF may be denoted by f(h_{1,15},h_{1,16},h_{1,17},h₁₇,h_{2,17},h_{2,18},h_{2,19}). The required density value may be obtained by integration:

f(h*_{,15},h*_{,16},h*_{,17},h*_{,18},h*_{,19})=∫f(h*_{,15},h*_{,16},h*_{,17}h*_{,18}h*_{,19})dh_{1,17}dh_{2,17}

where f(h*_{,15},h*_{,16},h*_{,17},h*_{,18},h*_{,19})=f(c_{Λ(i)}|g_{1,Λ(i)},g_{2,Λ(i)},w,x).

The integration can be achieved using any type of integration, including, but not limited to, Monte Carlo integration, and numerical integration. The preferred method is adaptive numerical integration in one dimension in this example, and in several dimensions in general.

The general method may generate an intermediate PDF using the PDF of the contributor and by introducing δₛ PDFs for the height pairs that fall in the same position.

The method may provide that if one of the observed heights is below the limit-of-detection threshold T_{d}, further integration to consider all values may be performed. For example if h{*,15} is reported as below the limit-of-detection threshold T_{d} and all other heights are greater than the limit-of-detection threshold, the PDF value may become a likelihood given by:

f(h*_{,15}<T_{d},h*_{,16},h*_{,17},h*_{,18},h*_{,19})=∫ₕ*_{,15}_{^{<T}}_{d}f(h₁₅,h*_{,16},h*_{,17},h*_{,18},h*_{,19})dh₁₅

The integral may consider all the possibilities for h₁₅. In general the method may need to perform an integration for each height that is smaller than T_{d}. Any method for calculating the integral can be used. The preferred method is adaptive numerical integration.

The method of comparing may be used to gather information to assist further investigations or legal proceedings. The method of comparing may provide intelligence on a situation. The method of comparison may be of the likelihood of the information of the first or test sample result given the information of the second or another sample result. The method of comparison may provide a listing of possible another sample results, ideally ranked according to the likelihood. The method of comparison may seek to establish a link between a DNA profile from a crime scene sample and one or more DNA profiles stored in a database.

The method of comparing may provide a link between a DNA profile, for instance from a crime scene sample, and one or more profiles, for instance one or more profiles stored in a database.

The method of comparing may consider a crime profile with the crime profile consisting of a set of crime profiles, where each member of the set is the crime profile of a particular locus. The method may propose, for instance as its output, a list of profiles from the database. The method may propose a posterior probability for one or more or each of the profiles. The method may propose, for instance as its output, a list of profiles, for instance ranked such that the first profile in the list is the genotype of the most likely donor.

The method may include, where the profile is from a single source, a single suspect's profile and posterior probability being generated.

The method may include computing the posterior probability, p(gᵢ|c), for all possible genotypes across the profile, gᵢ. This quantity may be defined as:

$$p ( {g}_{i} \vert c ) = \frac{f ( c \vert {g}_{i} ) p ( {g}_{i} )}{{\sum }_{{g}_{j}} f ( c \vert {g}_{j} ) p ( {g}_{j} )}$$

where p(gᵢ) is a prior distribution for genotype gᵢ, preferably computed from the population in question.

The method may include the likelihood f(c|g) being computed with the replacement of the suspect's genotype by one of the generated gᵢ.

The method may include conditioning on DNA quantity.

The method may include the use of the computation:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

The method may include, where L_{p,L(j)}(χᵢ) is the likelihood for locus j conditional on DNA quantity, the form:

L_{p,L(j)}(χ)=f(c_{L(j)}|g_{s,L(j)},Vₚ,χⱼ)

and/or:

L_{p,L(j)}(χ)=f(c_{L(j)}|gₕ₍ⱼ₎,V,χⱼ).

and/or:

$${\sum }_{{χ}_{i}} [ {\prod }_{j}^{n loci} f ( {c}_{h ( j )} \vert {g}_{s , L ( j )} , {V}_{p} , {χ}_{i} ) ] p ( {χ}_{i} )$$

The method may include the prior probability p(gᵢ|c) being computed as:

p(gᵢ)=Πₖ₌₁ⁿ^{_{loci}}p(g_{i,L(k)})

The method may include, one or more or each factor in the product p(gᵢ)=Πₖ₌₁ⁿ^{_{loci}}p(g_{i,L(k)}) being computed using an approach. The approach may include the approach inputs being or including one or more of: g—a genotype; alleleList—a list of observed alleles; locus—an identifier for the locus; theta—a co-ancestry or inbreeding coefficient—potentially a real number in the interval [0,1]; eaGroup—ethnic appearance group—potentially an identifier for the ethnic group appearance, which can change from country to country; alleleCountArray—an array of integers containing counts corresponding to a list of alleles and loci. The approach may include the approach outputs being or including one or more of: Prob—a probability—potentially a real number with interval [0,1]. The approach may include an algorithmical description including or being:
a) if g is a heterozygote, then multiply by 2; and/or
b) N=length(g)+length(allelelist); and/or
c) den=[1+(N−2)θ][1+(N−3)θ]; and/or
d) n₁ is the number of times that the first allele g(1) is present in allelelist ∪ g(2); and/or
e) n₂ is the number of times that the second allele g(2) is present in the list alleleList; and/or.
f) num=[(n₁−1)θ+(1−θ)*p₁][(n₂−1)θ+(1−θ)*p₂] where p₁ is the probability of allele g(1) and p₂ is the probability of allele g(2).

The method may include, where the profile is from two sources, a pair of suspect profiles and a posterior probability being generated. The method may include, where the profile is from n sources, a group of n suspect profiles and a posterior probability being generated, n being a positive integer.

The method may include a probability distribution for the genotypes being calculated, potentially according to the formula:

$$p ( {g}_{1} , {g}_{2} \vert c ) = \frac{f ( c \vert {g}_{1} , {g}_{2} ) p ( {g}_{1} , {g}_{2} )}{{\sum }_{gi , gj} f ( c \vert {g}_{i} , {g}_{j} ) p ( {g}_{i} , {g}_{j} )}$$

where p(g₁,g₂) and/or p(gᵢ,gⱼ) are a prior distribution for the pair of genotypes inside the brackets, potentially with the prior distribution being set to a uniform distribution and/or being computed using the formulae introduced by Balding et al. The method may exclude computing the denominator and/or the method may include assuming the denominator to extend to all possible genotypes.

The method may include the calculation of the likelihood f(c|g₁,g₂). The likelihood may be computed according to the formula:

$$f ( c \vert {g}_{1} , {g}_{2} ) = {\sum }_{x} {\sum }_{w} {\prod }_{i}^{{n}_{loci}} f ( {c}_{L ( i )} \vert {g}_{1 , L ( i )} , {g}_{2 , L ( i )} ) p ( w ) p ( x )$$

for instance, where the term:

$$p ( {g}_{1} , {g}_{2} ) = {\prod }_{i}^{{n}_{loci}} p ( {g}_{1 , L ( i )} \vert {g}_{2 , L ( i )} ) p ( {g}_{1 , L ( i )} ) .$$

The method may include, one or more or each factor in the product

$$p ( {g}_{1} , {g}_{2} ) = {\prod }_{i}^{{n}_{loci}} p ( {g}_{1 , L ( i )} \vert {g}_{2 , L ( i )} ) p ( {g}_{1 , L ( i )} )$$

being computed using an approach. The approach may include the approach inputs being or including one or more of: g—a genotype; alleleList—a list of observed alleles; locus—an identifier for the locus; theta—a co-ancestry or inbreeding coefficient—potentially a real number in the interval [0,1]; eaGroup—ethnic appearance group—potentially an identifier for the ethnic group appearance, which can change from country to country; alleleCountArray—an array of integers containing counts corresponding to a list of alleles and loci. The approach may include the approach outputs being or including one or more of: Prob—a probability—potentially a real number with interval [0,1]. The approach may include an algorithmical description including or being:
g) if g is a heterozygote, then multiply by 2; and/or
h) N=length(g)+length(allelelist); and/or
i) den=[1+(N−2)0][1+(N−3)0]; and/or
j) n₁ is the number of times that the first allele g(1) is present in allelelist ∪ g(2); and/or
k) n₂ is the number of times that the second allele g(2) is present in the list alleleList; and/or.
l) num=[(n₁−1)θ+(1−θ)*p₁][(n₂−1)θ+(1−θ)*p₂] where p₁ is the probability of allele g(1) and p₂ is the probability of allele g(2).

According to a second aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses as the definition of the numerator in a likelihood ratio the factor:

$${\sum }_{{χ}_{i}} [ {\prod }_{j}^{n loci} f ( {c}_{h ( j )} \vert {g}_{s , L ( j )} , {V}_{p} , {χ}_{i} ) ] p ( {χ}_{i} ) .$$

The second aspect of the invention may include any of the features, options or possibilities set out elsewhere in this document, including in the other aspects of the invention.

According to a third aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses as the definition of the denominator in a likelihood ratio the factor:

$${\sum }_{{χ}_{i}} [ {\prod }_{j}^{n loci} \sum f ( {c}_{L ( j )} \vert {g}_{u , L ( j )} , {V}_{d} , {χ}_{i} ) \times p ( {g}_{u , L ( j )} \vert {g}_{s , L ( j )} ) ] p ( {χ}_{i} ) .$$

The third aspect of the invention may include any of the features, options or possibilities set out elsewhere in this document, including in the other aspects of the invention.

According to a fourth aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses in the definition of the numerator and/or denominator in a likelihood ratio the factor: f(c_{L(j)}|gₕ₍ⱼ₎,V,χⱼ).

The fourth aspect of the invention may include any of the features, options or possibilities set out elsewhere in this document, including in the other aspects of the invention.

According to a fifth aspect of the invention we provide a method for generating one or more probability distribution functions relating to the detected level for a variable characteristic of DNA, the method including:

a) providing a control sample of DNA;

b) analysing the control sample to establish the detected level for the at least one variable characteristic of DNA;

c) repeating steps a) and b) for a plurality of control samples to form a data set of detected levels;

d) defining a probability distribution function for at least a part of the data set of detected levels.

The method may particularly be used to generate one or more of the probability distribution functions provided elsewhere in this document

The fifth aspect of the invention may include any of the features, options or possibilities set out elsewhere in this document, including in the other aspects of the invention.

Any of the proceeding aspects of the invention may include the following features, options or possibilities or those set out elsewhere in this document.

The terms peak height and/or peak area and/or peak volume are all different measures of the same quantity and the terms may be substituted for each other or expanded to cover all three possibilities in any statement made in this document where one of the three are mentioned.

The method may be a computer implemented method.

The method may involve the display of information to a user, for instance in electronic form or hardcopy form.

The test sample, may be a sample from an unknown source. The test sample may be a sample from a known source, particularly a known person. The test sample may be analysed to establish the identities present in respect of one or more variable parts of the DNA of the test sample. The one or more variable parts may be the allele or alleles present at a locus. The analysis may establish the one or more variable parts present at one or more loci.

The test sample may be contributed to by a single source. The test sample may be contributed to by an unknown number of sources. The test sample may be contributed to by two or more sources. One or more of the two or more sources may be known, for instance the victim of the crime.

The test sample may be considered as evidence, for instance in civil or criminal legal proceedings. The evidence may be as to the relative likelihoods, a likelihood ratio, of one hypothesis to another hypothesis. In particular, this may be a hypothesis advanced by the prosecution in the legal proceedings and another hypothesis advanced by the defence in the legal proceedings.

The test sample may be considered in an intelligence gathering method, for instance to provide information to further investigative processes, such as evidence gathering. The test sample may be compared with one or more previous samples or the stored analysis results therefore. The test sample may be compared to establish a list of stored analysis results which are the most likely matches therewith.

The test sample and/or control samples may be analysed to determine the peak height or heights present for one or more peaks indicative of one or more identities. The test sample and/or control samples may be analysed to determine the peak area or areas present for one or more peaks indicative of one or more identities. The test sample and/or control samples may be analysed to determine the peak weight or weights present for one or more peaks indicative of one or more identities. The test sample and/or control samples may be analysed to determine a level indicator for one or more identities.

Various embodiments of the invention will now be described, by way of example only, and with reference to the accompanying drawings, in which:

FIG. 1 shows a Bayesian network for calculating the numerator of the likelihood ratio; the network is conditional on the prosecution view Vₚ. The rectangles represent know quantities. The ovals represent probabilistic quantities. Arrows represent probabilistic dependencies, e.g. the PDF of C_{L(1)} is given for each value of g_{s,L(1)} and χ.

FIG. 2a illustrates an example of a profile for a homozygous source;

FIG. 2b is a Bayesian Network for the homozygous position;

FIG. 2c is a further Bayesian Network for the homozygous position;

FIG. 2d shows homozygote peak height as a function of DNA quantity; with the straight line specified by h̅=−12.94+1.27×χ.

FIG. 2e shows the parameters of a Beta PDF that model stutter proportion πₛ conditional on parent allele height h.

FIG. 3a illustrates an example of a profile for a heterozygous source whose alleles are in non-stutter positions relative to one another;

FIG. 3b is a Bayesian Network for the heterozygous position with non-overlapping allele and stutter peaks;

FIG. 3c is a further Bayesian Network for the heterozygous position with non-overlapping allele and stutter peaks;

FIG. 3e shows the variation in density with mean height for a series of Gamma distributions;

FIG. 3f shows the variation of parameter σ as a function of mean height m;

FIG. 4a illustrates an example of a profile for a heterozygous source whose alleles include alleles in stutter positions relative to one another;

FIG. 4b is a Bayesian Network for the heterozygous position with overlapping allele and stutter peaks;

FIG. 4c is a further Bayesian Network for the heterozygous position with overlapping allele and stutter peaks;

FIG. 5 shows a Bayesian network for calculating the denominator of the likelihood ratio. The network is conditional on the defence hypothesis V_{d}. The oval represent probabilistic quantities whilst the rectangles represent known quantities. The arrows represent probabilistic dependencies;

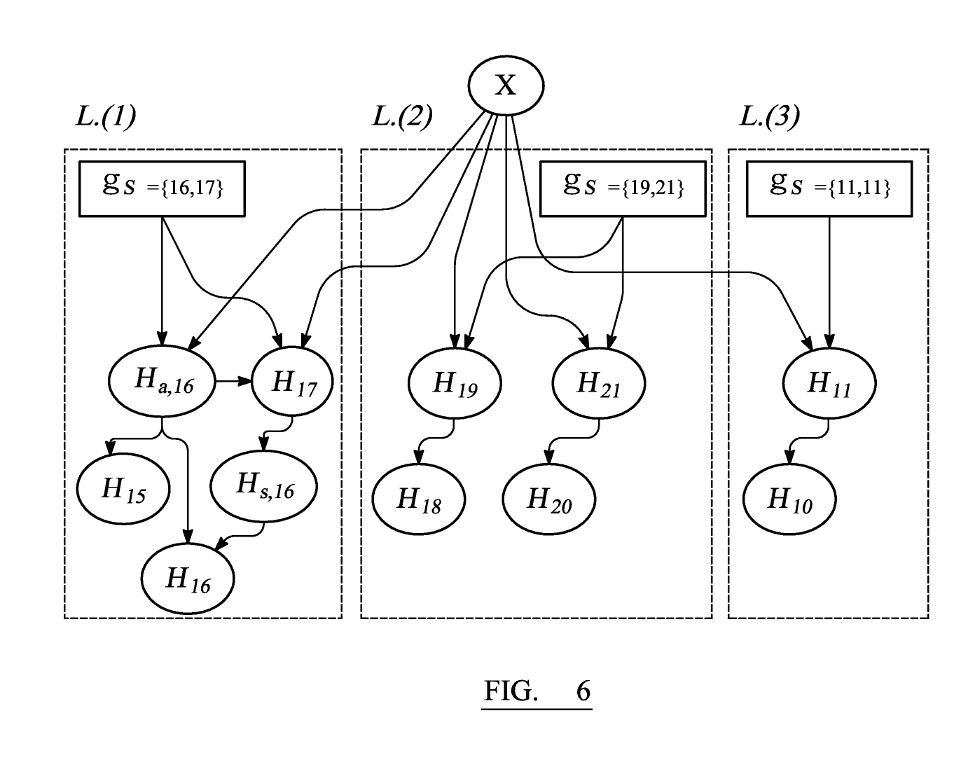

FIG. 6 shows a Bayesian Network for calculating likelihood per locus in a generic example;

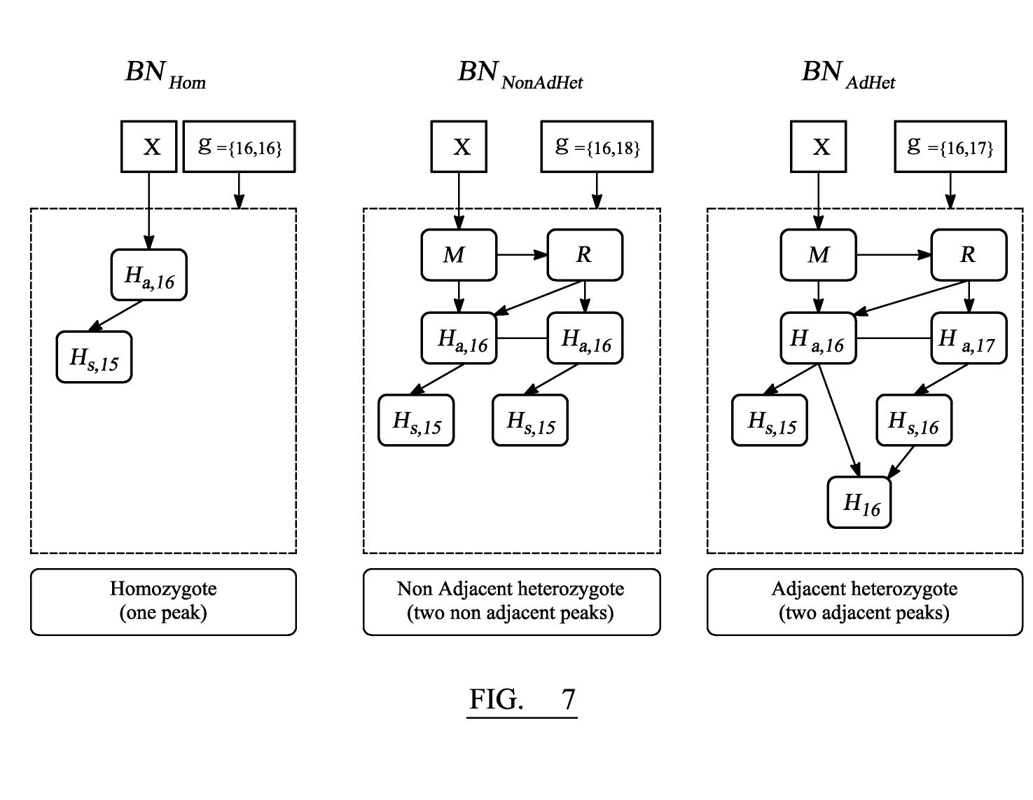

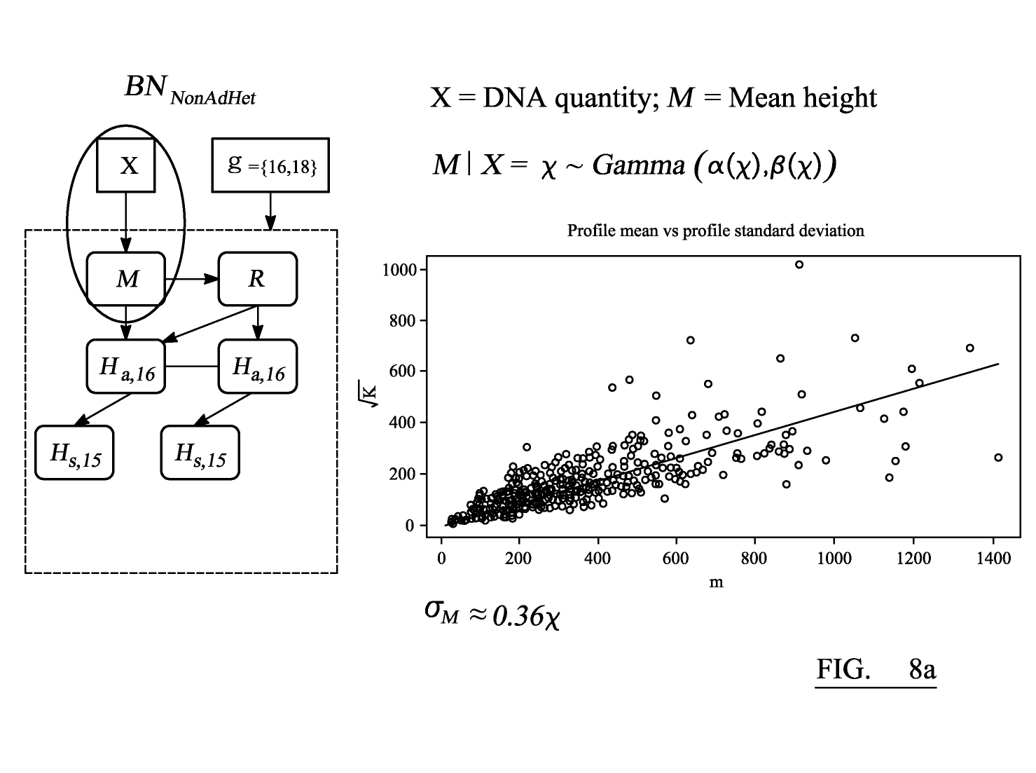

FIG. 7 shows a Bayesian Network for each of these three forms: left to right: homozygote; non-adjacent heterozygote; adjacent heterozygote;

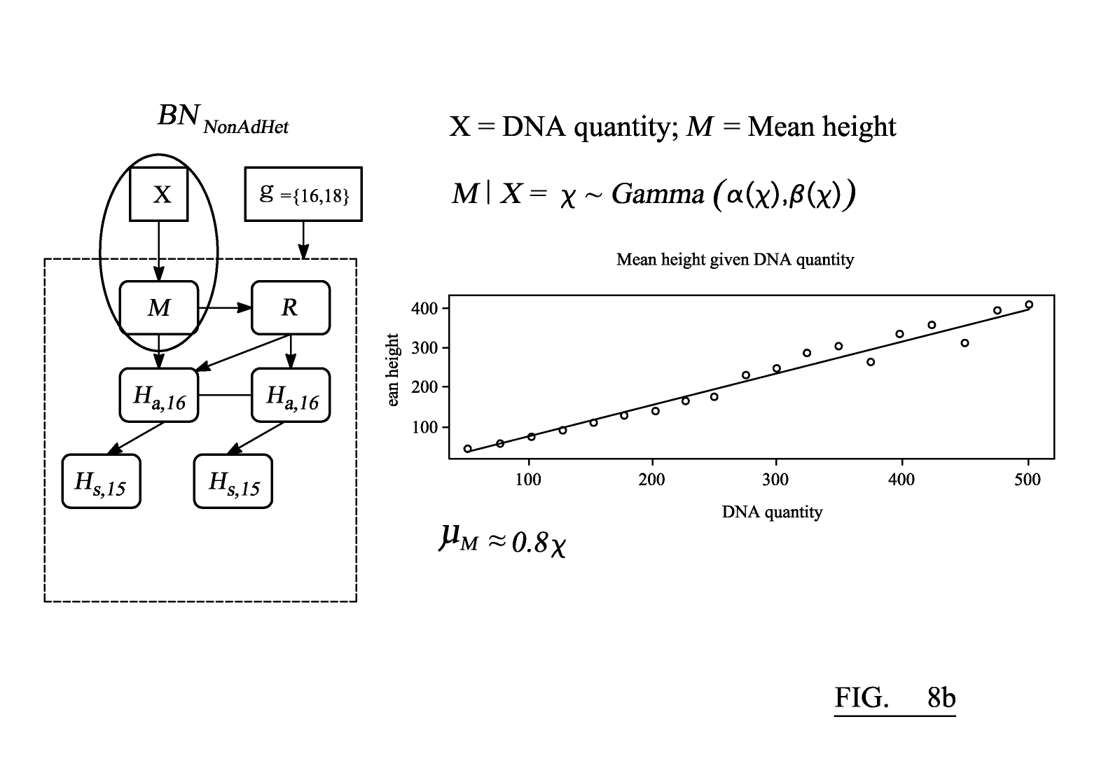

FIG. 8a provides an illustration of variance modeling, with the value of profile mean plotted against profile standard deviation;

FIG. 8b provides a further illustration of the variation in mean height with DNA quantity; and

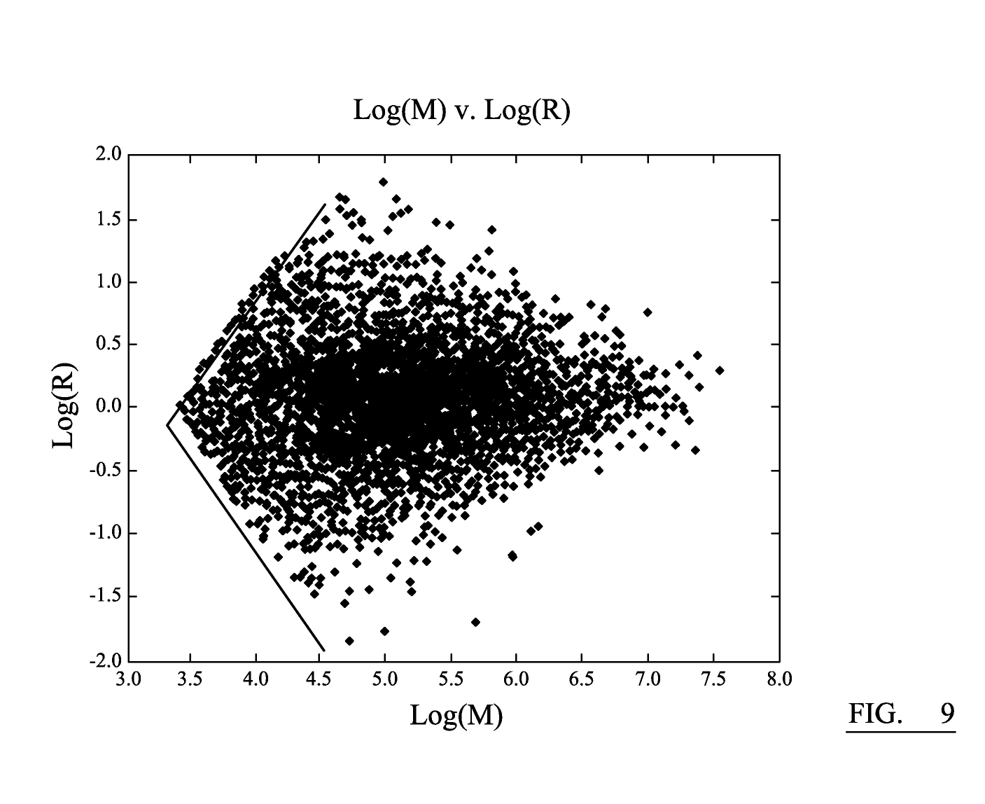

FIG. 9 illustrates a PDF for R|M=m.

### 1. BACKGROUND

The present invention is concerned with improving the interpretation of DNA analysis. Basically, such analysis involves taking a sample of DNA, preparing that sample, amplifying that sample and analysing that sample to reveal a set of results. The results are then interpreted with respect to the variations present at a number of loci. The identities of the variations give rise to a profile.

The extent of interpretation required can be extensive and/or can introduce uncertainties. This is particularly so where the DNA sample contains DNA from more than one person, a mixture.

The profile itself has a variety of uses; some immediate and some at a later date following storage.

There is often a need to consider various hypotheses for the identities of the persons responsible for the DNA and evaluate the likelihood of those hypotheses, evidential uses.

There is often a need to consider the analysis genotype against a database of genotypes, so as to establish a list of stored genotypes that are likely matches with the analysis genotype, intelligence uses.

Previously the generally accepted method for assigning evidential weight of single profiles is a binary model. After interpretation, a peak is either in the profile or is excluded from the profile.

When making the interpretation, quantitative information is considered via thresholds which determine decisions and via expert opinion. The thresholds seek to deal with allelic dropout, in particular; the expert opinion seeks to deal with heterozygote imbalance and stutters, in particular. In effect, these approaches acknowledged that peak heights and/or areas and/contain valuable information for assigning evidential weight, but the use made is very limited and is subjective.

The binary nature of the decision means that once the decision is made, the results only include that binary decision. The underlying information is lost.

Previously, as exemplified in International Patent Application no PCT/GB2008/003882, a specification of a model for computing likelihood ratios (LRs) that uses peak heights taken from such DNA analysis has been provided. This quantified and modeled the relationship between peaks observed in analysis results. The manner in which peaks move in height (or area) relative to one another is considered. This makes use of a far greater part of the underlying information in the results.

### 2. OVERVIEW

The aim of this invention is to describe in detail the statistical model for computing likelihood ratios for single profiles while considering peak heights, but also taking into consideration allelic dropout and stutters. The invention then moves on to describe in detail the statistical model for computing likelihood ratios for mixed profiles which considering peak heights and also taking into consideration allelic dropout and stutters.

The present invention provides a specification of a model for computing likelihood ratios (LR's) given information of a different type in the analysis results. The invention is useful in its own right and in a form where it is combined with the previous model which takes into account peak height information.

One such different type of information considered by the present invention is concerned with the effect known as stutter.

Stutter occurs where, during the PCR amplification process, the DNA repeats slip out of register. The stutter sequence is usually one repeat length less in size than the main sequence. When the sequences are separated using electrophoresis to separate them, the stutter sequence gives a band at a different position to the main sequence. The signal arising for the stutter band is generally of lower height than the signal from the main band. However, the presence or absence of stutter and/or the relative height of the stutter peak to the main peak is not constant or fully predictable. This creates issues for the interpretation of such results. The issues for the interpretation of such results become even more problematic where the sample being considered is from mixed sources. This is because the stutter sequence from one person may give a peak which coincides with the position of a peak from the main sequence of another person. However, whether such a peak is in part and/or wholly due to stutter or is nothing to do with stutter is not a readily apparent position.

A second different type of information considered by the present invention is concerned with dropout.

Dropout occurs where a sequence present in the sample is not reflected in the results for the sample after analysis. This can be due to problems specific to the amplification of that sequence, and in particular the limited amount of DNA present after amplification being too low to be detected. This issue becomes increasingly significant the lower the amount of DNA collected in the first place is. This is also an issue in samples which arise from a mixture of sources because not everyone contributes an equal amount of DNA to the sample.

The present invention seeks to make far greater use of a far greater proportion of the information in the results and hence give a more informative and useful overall result.

To achieve this, the present invention includes the use of a number of components. The main components are:
1. An estimated PDF for homozygote peaks conditional on DNA quantity; discussed in detail in LR Numerator Quantification Category 1;
2. An estimated PDF for stutter heights conditional on the height of the parent allele; discussed in detail in LR Numerator Quantification Category 1;
3. An estimated joint probability density function (PDF) of peak height pairs conditional on DNA quantity; discussed in detail in LR Numerator Quantification Category 2. The peak heights are right censored by the limit of detection threshold T_{d}. Below this threshold it is not safe to designate alleles, as the peaks are too close to the baseline to be distinguished from other elements in the signal. Threshold T_{d} can be different to the limit-of-detection threshold at 50 rfu suggested by the manufacturers of typical instruments analysing such results.
4. A latent variable X representing DNA quantity that models the variability of peak heights across the profile. It does not consider degradation, but degradation can be incorporated by adding another latent variable Δ that discounts DNA quantity according to a numerical representation of the molecular weight of the locus.
5. The calculation of the LR is done separately for the numerator and the denominator. The overall joint PDF for the numerator and the denominator can be represented with Bayesian networks (BNs).

### 3. DETAILED DESCRIPTION—SINGLE PROFILE

### 3.1—The Calculation of the Likelihood Ratio

The explanation provides:
a definition of the Likelihood Ratio, LR, to be considered;
then considers the numerator, its component parts and the manner in which they are determined;
then considers the denominator, its component parts and the manner in which they are determined;
then combines the position reached in a further discussion of the LR.

The explanation is supplemented by the specifics of the approach in particular cases.

An LR summarises the value of the evidence in providing support to a pair of competing propositions: one of them representing the view of the prosecution (Vₚ) and the other the view of the defence (V_{d}). The usual propositions are:
1) Vₚ: The suspect is the donor of the DNA in the crime stain;
2) V_{d}: Someone else is the donor of the DNA in the crime stain.

The possible values that a crime stain can take are denoted by C, the possible values that the suspect's profile can take are denoted by Gₛ. A particular value that C takes is written as c, and a particular value that Gₛ takes is denoted by gₛ. In general, a variable is denoted by a capital letter, whilst a value that a variable takes is denoted by a lower-case letter.

We are interested in computing

$$LR = \frac{p ( c , gs \vert {V}_{p} )}{p ( c , gs \vert {V}_{d} )} = \frac{f ( c \vert gs , {V}_{p} )}{f c \vert gs , {V}_{d} )}$$

In effect f is a model of how the peaks change with different situations, including the different situations possible and the chance of each of those.

The crime profile c in a case consists of a set of crime profiles, where each member of the set is the crime profile of a particular locus. Similarly, the suspect genotype gₛ is a set where each member is the genotype of the suspect for a particular locus. We use the notation:

c={c_{L(i)}:i=,2, . . . , n_{Loci}} and gs={gs,_{L(i)}:=1,2, . . . , n_{Loci}}

where n_{Loci} is the number of loci in the profile.

### 3.2—The LR Numerator Form

The calculation of the numerator is given by:

Lₚ=f(c|gₛ,Vₚ)

Because peak height is dependent between loci and needs to be rendered independent, the likelihood Lₚ is factorised conditional on DNA quantity χ. This is because the peak height between loci is also dependent on DNA quantity. This gives:

Lₚ=f(cₕ|gₛ,h,χ,Vₚ)

It will be recalled, that c is a crime profile across loci consisting of per locus profiles, so for a three locus form c={c_{L(1)}, c_{L(2)}, c_{L(3)}} and similarly for gₛ. We can therefore write the initial equation as:

Lₚ=f(c_{L(1)},c_{L(2)},c_{L(3)},|g_{s,L(1)},g_{s,L(2)},g_{s,L(3)},Vₚ)

The combination of the two previous equations, to give conditioning on quantity and expansion per locus gives:

Lₚ=f(c_{L(1)}|g_{s,L(1)},χᵢ,Vₚ)×f(c_{L(2)}|g_{s,L(2)},χᵢ, Vₚ)×f(c_{L(3)}|g_{s,L(3)},χᵢ,Vₚ)

Which can be stated as:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

Where L_{p,L(j)}(χᵢ) is the likelihood for locus j conditional on DNA quantity, this assumes the abstracted form:

L_{p,L(j)}(χ)=f(c_{L(j)}|g_{s,L(j)},Vₚ,χⱼ)

or:

L_{p,L(j)}(χ)=f(c_{L(j)}|gₕ₍ⱼ₎,V,χⱼ)

A pictorial description of this calculation is given by the Bayesian Network illustrated in FIG. 1. The Bayesian network is for calculating the numerator of the likelihood ratio; hence, the network is conditional on the prosecution view Vₚ. The rectangles represent know quantities. The ovals represent probabilistic quantities. Arrows represent probabilistic dependencies, e.g. the PDF of C_{L(1)} is given for each value of g_{s,L(1)} and χ.

Here we assume that the crime profile C_{L(i)} is conditionally independent of C_{L(j)} given DNA quantity X for i≠j,i,j ∈ {1,2, . . . , n_{L}}. It can be written as:

C_{L(1)} [symbol] C_{L}_{ⱼ}_{|}X

In the Bayesian Network we can see that a path from C_{L(1)} to C_{L(2)} passes through χ.

We also assume that is sufficient to use a discrete probability distribution on DNA quantity as an approximation to a continuous probability distribution. This discrete probability distribution is written as {Pr(χ=_{χ}_{ⁱ}):i=1,2, . . . , nₓ}. It can be written simply by {p(χᵢ):i=1,2, . . . , n_{χ}}.

The likelihood in L_{p,L(j)}(χ)=f(c_{L(j)|}g_{s,L(j)},Vₚ,X) specified a likelihood of the heights in the crime profile given the genotype of a putative donor, and so, they can be written as:

L_{L(j)}(χ)=f(c_{L(j)|}g_{L(j)},V,χ)

where V states that the genotype of the donor of crime profile c_{L(i)} is g_{L(j)}. The calculation of the likelihood is discussed below after the discussion of the denominator.

In general terms, the numerator can be stated as:

$${\sum }_{{χ}_{i}} [ {\prod }_{j}^{n loci} f ( {c}_{h ( j )} \vert {g}_{s , L ( j )} , {V}_{p} , {χ}_{i} ) ] p ( {χ}_{i} )$$

where the consideration is in effect, the genotype (gₛ) is the donor of (cₕ₍ⱼ₎) given the DNA quantity (χᵢ).

The general statements provided above for the numerator enable a suitable numerator to be established for the number of loci under consideration.

### 3.3—The LR Numerator Quantification

All LR calculations fall into three categories. These apply to the numerator and, as discussed below, the denominator. The genotype of the profile's donor is either:
1) a heterozygote with adjacent alleles; or
2) a heterozygote with non-adjacent alleles; or
3) a homozygote.
   A Bayesian Network for each of these three forms is shown in FIG. 7; left to right, homozygote; non-adjacent heterozygite; adjacent heterozygote.

### 3.3.1—Category 1: Homozygous Donor

### 3.3.1.1—Stutter

FIG. 2a illustrates an example of such a situation. The example has a profile, c_{L(3)}={h₁₀,h₁₁} arising from a genotype, g_{L(3)}={11,11}. The consideration is of a donor which is homozygous giving a two peak profile, potentially due to stutter.

This position can be stated in the Bayesian Network of FIG. 2b. The stutter peak height for allele 10, H_{stutter,10}, is dependent upon the allele peak height 11, H_{allele,11}, which in turn is dependent upon the DNA quantity, χ.

In this context, χ, is assumed to be a known quantity. H_{stutter,10} is a probability distribution function, PDF, which represents the variation in height of the stutter peak with variation in height of the allele peak, H_{allele,11}. H_{allele,11} is a probability distribution, PDF, which represent the variation in height of the allele peak with variation in DNA quantity. In effect, there is a PDF for stutter peak height for each value within the PDF for the allele peak height. The concept is illustrated in FIG. 2c. In the first case shown in FIG. 2c, the allele peak has a height h and the stutter PDF has a range from 0 to x. In the second case shown, the allele peak has a greater height, h+ and the stutter PDF has a range of 0 to x+. Different values within the range have different probabilities of occurrence.

3.3.1.2—PDF for Allele Peak Height with DNA Quantity—Details

The PDF for allele peak height, H_{allele,11} in the example, can be obtained from experimental data, for instance by measuring allele peak height for a large number of different, but known DNA quantities.

The model for peak height of homozygote donors is achieved using a Gamma distribution for the PDF, f(h|χ), for peak heights of homozygote donors given DNA quantity χ.

A Gamma PDF is fully specified through two parameter: the shape parameter α and the rate parameter β. These parameters are specified through two parameters: the mean height h̅, which models the mean value of the homozygote peaks, and parameter k that models the variability of peak heights for the given DNA quantity χ.

The mean value h̅ is calculated through a linear relationship between mean heights and DNA quantity, as shown in FIG. 2d. The equation of the straight line is given by:

h̅=−12.94+1.27×χ

The line was estimated and plotted using fitHomPDFperX.r. The plot was produced with plot_HomHgivenXPDFs.r.

The variance is modeled with a factor k which is set to 10. The parameters α and β of the Gamma distribution are:

α= h̅/k and β=α/ h̅

3.3.1.3—PDF for Stutter Peak Height with Allele Peak Height—Details

The PDF for stutter peak height, H_{stutter,10} in the example, can also be obtained from experimental data, for instance by measuring the stutter peak height for a large number of different, but known DNA quantity samples, with the source known to be homozygous. These results can be obtained from the same experiments as provide the allele peak height information mentioned in the previous paragraph.

For each parent height there is a Beta distribution describing the probabilistic behaviour of the stutter height. The generic formula for a Beta PDF is:

$$f ( y \vert α , β ) = \frac{Γ ( α + β )}{Γ ( α ) Γ ( β )} {{y}^{α - 1} ( 1 - y )}^{β - 1}$$

The conditional PDF f_{H}_{ₛ}|_{H} is in fact specified through the parameters of the Beta distribution that models stutter proportions, that is, stutter height divided by parent allele height. More specifically

$${f}_{{H}_{s}} {\vert}_{H} ( {h}_{s} \vert h ) = \frac{1}{h} \times f {π}_{s} {\vert}_{H} ( {π}_{s} \vert α ( h ) , β ( h ) )$$

where α(h) and β(h) are the parameters of a Beta PDF. Notice that α(h) and β(h) are dependent, or functions of the height h of the parent allele. FIG. 2e shows a plot of the parameters as a function of h. These values will be stored digitally.

### 3.3.1.4 Further Details

The methodology can be applied with a PDF for allele height for all loci, but preferably with a separate PDF for allele height for each locus considered. A separate PDF for each allele at each locus is also possible. The methodology can be applies with a PDF for stutter height for all loci, but preferably with a separate PDF for stutter height at each locus considered. A separate PDF for each allele at each locus is also possible.

In an example where locus three is under consideration and the allele peak is 11 and stutter peak is 10, the PDF for this case is given by the formula:

f_{L(3)}(h₁₀,h₁₁)=fₛ(h₁₀|h₁₁)fₕₒₘ(h₁₁)

This formula can be abstracted to give the generic form:

f_{L(j)}(hₛₜᵤₜₜₑᵣ,hₐₗₗₑₗₑ)=fₛ(hₛₜᵤₜₜₑᵣ|hₐₗₗₑₗₑ)fₕₒₘ(hₐₗₗₑₗₑ)

with the manner for obtaining the PDF's as described above.

### 3.3.1.5—Extension to Possible Dropout

The formula f_{L(3)}(h₁₀,h₁₁), more generically, f_{L(j)}(hₐₗₗₑₗₑ₁,hₐₗₗₑₗₑ₂), gives density values for any positive value of the arguments. In many occasions either technical dropout or dropout has occurred and therefore we need to perform some integrations. Three possible cases are considered.

Possible Case One—h₁₀≧T_{d},h₁₁≧T_{d}

If both heights in c_{L(3)} are taller than the limit of detection threshold T_{d}, then the numerator is given by

L_{L(3)}(χ)=f_{L(3)}(h₁₀,h₁₁)

Or generically as:

L_{L(j)}(χ)=f_{L(j)}(hₐₗₗₑₗₑ₁,hₐₗₗₑₗₑ₂)

Possible Case Two—h₁₀ [symbol] T_{d},h₁₁≧T_{d}

In this case the height of the stutter is less than the limit-of-detection threshold and so, we need to perform one integral.

L_{L(3)}(χ)=∫₀^{T}^{_{d}}f_{L(3)}(h₁₀,h₁₁)dh₁₀

It can be approximated by:

$${L}_{L ( 3 )} ( χ ) \approx {\sum }_{{h}_{10} = 1}^{{T}_{d}} {f}_{L ( 3 )} ( {h}_{10} , {h}_{11} )$$

Or more generically as:

$${L}_{L ( j )} ( χ ) \approx {\sum }_{{h}_{allele 1} = 1}^{{T}_{d}} {f}_{L ( j )} ( {h}_{allele 1} , {h}_{allele 2} )$$

Possible Case Three—h₁₀ [symbol] T_{d},h₁₁ [symbol] T_{d}

In this case, the height of both the peaks is less than the limit of detection threshold.

L_{L(3)}(χ)=∫₀^{T}^{_{d}}∫ₕ_{₁₀}^{T}^{_{d}}f_{L(3)}(h₁₀,h₁₁)dh₁₀dh₁₁.

It can be approximated by:

$${L}_{L ( 3 )} ( χ ) \approx {\sum }_{{h}_{10} = 1}^{{T}_{d}} {\sum }_{{h}_{11} = {h}_{10} + 1}^{{T}_{d}} {f}_{L ( 3 )} ( {h}_{10} , {h}_{11} )$$

Or more generically as:

$${L}_{L ( j )} ( χ ) \approx {\sum }_{{h}_{allele 1} = 1}^{{T}_{d}} {\sum }_{{h}_{allele 2} = {h}_{allele 1} + 1}^{{T}_{d}} {f}_{L ( j )} ( {h}_{allele 1} , {h}_{allele 2} )$$

3.3.2—Category 2: Heterozygous Donor with Non-Adjacent Alleles

### 3.3.2.1—Stutter

FIG. 3a illustrates an example of such a situation. The example has a profile, c_{L(2)}={h₁₈,h₁₉,h₂₀,h₂₁}, arising from a genotype, g_{L(2)}={19,21}. The consideration is of a donor which is heterozygous, but the peaks are spaced such that a stutter peak cannot contribute to an allele peak. The same approach applies where the allele peaks are separated by two or more allele positions.

This position can be stated as in the Bayesian Network of FIG. 3b. The stutter peak height for allele 18, H_{stutter,18}, is dependent upon the allele peak height for allele 19, H_{allele,19}, which is in turn dependent upon the DNA quantity, χ. The stutter peak height for allele 20, H_{stutter,20}, is dependent upon the allele peak height for allele 21, H_{allele,21}, which is in turn dependent upon the DNA quantity, χ.

In this context, χ, is assumed to be a known quantity. H_{stutter,18} is a probability distribution function, PDF, which represents the variation in height of the stutter peak with variation in height of the allele peak, H_{allele,19}. H_{allele,19} is a probability distribution, PDF, which represent the variation in height of the allele peak with variation in DNA quantity. H_{stutter,20} is a probability distribution function, PDF, which represents the variation in height of the stutter peak with variation in height of the allele peak, H_{allele,21}. H_{allele,21} is a probability distribution, PDF, which represent the variation in height of the allele peak with variation in DNA quantity.

These PDF's can be the same PDF's as described above in category 1, particularly where the same locus is involved. As previously mentioned, the PDF's for these different alleles and/or PDF's for these different stutter locations may be different for each allele.

The consistent nature of the PDF's with those described above means that a similar position to that illustrated in FIG. 2c occurs. Equally, these PDF's too can be obtained from experimental data.

FIG. 8b provides a further illustration of the variation in mean height with DNA quantity (similar to FIG. 2d). Whilst FIG. 8a provides an illustration of such variance modeling, with the value of profile mean plotted against profile standard deviation.

In addition, the Bayesian Network of FIG. 3b indicates that both the allele peak height for allele 19, H_{allele,19}, and the allele peak height for allele 21, H_{allele,21}, are dependent upon the heterozygous imbalance, R and the mean peak height, M, with those terms also dependent upon each other and upon the DNA quantity, χ.

The heterozygous imbalance is defined as:

$$r = \frac{{h}_{19}}{{h}_{21}}$$

or generically as:

$$r = \frac{{h}_{allele 1}}{{h}_{allele 2}}$$

The mean height is defined as:

$$m = \frac{{h}_{19} + {h}_{21}}{2}$$

or generically as:

$$m = \frac{{h}_{allele 1} + {h}_{allele 2}}{2}$$

The PDF for f(h₁₉,h₂₁) is defined as:

f(h₁₉,h₂₁)=|J|.f(r|m).f(m)

with the heterozygous imbalance, r, having a PDF of the log normal form, for each value of m, so as to give a family of log normal PDF's overall; and with the mean, m, having a PDF of gamma form, for each value of χ, with a series of discrete values for χ being considered.

FIG. 9 illustrates a PDF for R|M=m using such an approach.

### 3.3.2.2—Joint PDF for Peak Pair Heights—Details

Providing further detail on this, the specification of a joint distribution of pairs of peak heights h₁ and h₂ is described.

The specification is done by the specification of a joint distribution of mean height m and heterozygote imbalance, which is given by

$$( {h}_{1} , {h}_{2} ) ↦ ( m = \frac{{h}_{1} + {h}_{2}}{2} , r = \frac{{h}_{1}}{{h}_{2}} )$$

If we specify a joint PDF for mean height M and heterozygote imbalance R we can obtain a joint PDF for peak heights H₁ and H₂ using the formula:

$${f}_{H 1} {,}_{H 2} ( {h}_{1} , {h}_{2} \vert χ ) = \frac{1}{{h}_{2}^{2}} ( \frac{{h}_{1} + {h}_{2}}{2} ) \times {f}_{M , R} ( m , r \vert χ )$$

In fact we specify the joint distribution of M and R through the marginal distribution of M, f_{M}(m|χ), and the conditional distribution of R given M, f_{R}|_{M}(r|m). With these considerations the joint PDF for heights is given by the formula:

$${f}_{H 1} {,}_{H 2} ( {h}_{1} , {h}_{2} \vert χ ) = \frac{1}{{h}_{2}^{2}} ( \frac{{h}_{1} + {h}_{2}}{2} ) \times {f}_{R , M} ( r \vert m ) {f}_{M} ( m \vert χ )$$

Notice that the PDF for M is conditional on DNA quantity X. This is a feature in the model that allow for dependence among peak heights in a profile.

In the following description we specify the PDF's for M and R|M=m.

### 3.3.2.3—PDFs for Mean Height Given DNA Quantity—Details

The PDF f_{M}(m|χ) represents a family of PDF's for mean height, one for each value of DNA quantity. This model the behaviour of peak heights in a profile: the more DNA, the higher the peaks, of course, up to some variability.

The Gamma PDF is given by the formula:

$$f ( x α , β ) = \frac{1}{{s}^{α} Γ ( α )} {x}^{α - 1} {e}^{- x / s}$$

where s=1/β. Parameter α is the shape parameter, β is the rate parameter and so, s is the scale parameter.

Therefore, the specification of the Gamma PDF's is achieved through the specification of the parameter α and β parameters as a function of DNA quantity χ. We achieve this through two intermediary parameters m̅ and k that model the mean value and the variance of M, respectively. The mean of the Gamma distributions is given by a linear function. The equation of the line is:

m̅=−8.69+0.66×χ

The variance is controlled by a factor k, which is set to 10 although it will change in the future.

Now that we have the parameters m̅ and k, we can compute the parameters of α and β of a Gamma distribution using the formula:

α= m̅/k, β=α/ m̅

For illustrative purposes, a selection of the Gamma distributions is shown in FIG. 3e.

### 3.3.2.4—PDFs for Heterozygote Imbalance Given Mean Height—Details

The conditional PDFs of heterozygote imbalance are modeled with log normal PDFs whose PDF is given by

$${f}_{R} ( r \vert μ , σ ) = \frac{1}{r \times σ ( m ) \sqrt{2 π}} {exp}^{\frac{- {( ln ( r ) - μ )}^{2}}{2 σ ( m )}}$$

A Log normal PDF is fully specified through parameters μ and σ(m). The latter parameter is dependent on the mean height m by the plot in FIG. 3f. The transfer of the actual values can be done digitally. Currently the parameters are stored in log NPars.rData.

### 3.3.2.5—Further Details

As a result, PDF's have been determined for the six dependents in FIG. 3b.

Given the above, the Bayesian Network of FIG. 3b can be simplified to the form of FIG. 3c.

In an example where locus 2 is under consideration and the allele peaks are at 19 and 21 and the stutter peaks are at 18 and 20, the generic PDF for this calculation is given by the formula:

f_{L(2)}(h₁₈,h₁₉,h₂₀,h₂₁)=fₛ(h₁₈|h₁₉)fₛ(h₂₀|h₂₁)fₕₑₜ(h₁₉|h₂₁)

This formula can be abstracted to give the generic form:

f_{L(j)}(hₛₜᵤₜₜₑᵣ₁,hₐₗₗₑₗₑ₁,hₛₜᵤₜₜₑᵣ₂,hₐₗₗₑₗₑ₂)=fₛₜᵤₜₜₑᵣ(hₛₜᵤₜₜₑᵣ₁|hₐₗₗₑₗₑ₁)fₛₜᵤₜₜₑᵣ(hₛₜᵤₜₜₑᵣ₂|hₐₗₗₑₗₑ₂)fₕₑₜ(hₐₗₗₑₗₑ₁|hₐₗₗₑₗₑ₂)

The manner for obtaining the PDF's is as described above with respect to the simplified form too.

### 3.3.2.6—Extension to Possible Dropout

The formula f_{L(2)}(h₁₈,h₁₉,h₂₀,h₂₁), more generically f_{L(j)}(hₛₜᵤₜₜₑᵣ₁,hₐₗₗₑₗₑ₁,hₛₜᵤₜₜₑᵣ₂,hₐₗₗₑₗₑ₂), gives density values for any positive value of the arguments. In many occasions either technical dropout, where a peak is smaller than the limit-of-detection threshold T_{d}, or dropout, where a peak is in the baseline, have occurred and therefore we need to perform some integrations. Eight possible cases are considered.

Possible Case One—h₁₈≧T_{d},h₁₉≧T_{d},h₂₀≧T_{d},h₂₁≧T_{d}

In this case we do not need to compute any integration and

L_{L(2)}(χ)=f_{L(2)}(h₁₈,h₁₉,h₂₀,h₂₁)

Or more generically:

L_{L(j)}(χ)=f_{L(j)}(hₛₜᵤₜₜₑᵣ₁,hₐₗₗₑₗₑ₁,hₛₜᵤₜₜₑᵣ₂hₐₗₗₑₗₑ₂)

Possible Case Two—h₁₈≧T_{d},h₁₉≧T_{d},h₂₀ [symbol] T_{d},h₂₁ [symbol] T_{d}

In this case we need to compute two integrations:

L_{L(2)}(χ)=∫₀^{T}^{_{d}}∫ₕ_{₂₀}^{T}^{_{d}}f_{L(2)}(h₁₈,h₁₉,h₂₀,h₂₁)dh₂₀dh₂₁.

It can be approximated with the following summations:

$${L}_{L ( 2 )} ( χ ) \approx {\sum }_{{h}_{20} = 1}^{{T}_{d}} {\sum }_{{h}_{21} = {h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stuttere 2} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 2} , {h}_{stutter 2} , {h}_{allele 2} )$$

Possible Case Three—h₁₈ [symbol] T_{d},h₁₉≧T_{d},h₂₀≧T_{d},h₂₁≧T_{d}

In this case we need only one integration:

L_{L(2)}(χ)=∫₀^{T}^{_{d}}f_{L(2)}(h₁₈,h₁₉,h₂₀,h₂₁)dh₁₈

It can be approximated as summation:

$${L}_{L ( 2 )} ( χ ) \approx {\sum }_{{h}_{18} = 1}^{{T}_{d}} {f}_{L ( 2 )} ( {h}_{18} , {h}_{19} , {h}_{20} , {h}_{21} )$$

Or more generically as:

$${L}_{L ( j )} ( χ ) \approx {\sum }_{{h}_{stutter 1} = 1}^{{T}_{d}} {f}_{L ( j )} ( {h}_{stutter 1} , {h}_{allele 1} , {h}_{stutter 2} , {h}_{allele 2} )$$

Possible Case Four—h₁₈ [symbol] T_{d},h₁₉≧T_{d},h₂₀ [symbol] T_{d},h₂₁≧T_{d}

Two integrations are required. The likelihood is given by:

L_{L(2)}(χ)=∫₀^{T}^{_{d}}∫₀^{T}^{_{d}}f_{L(2)}(h₁₈,h₁₉,h₂₀,h₂₁)dh₁₈dh₂₀.

It can be approximated by:

$${L}_{L ( 2 )} ( χ ) \approx {\sum }_{{h}_{18} = 1}^{{T}_{d}} {\sum }_{{h}_{20} = 1}^{{T}_{d}} {f}_{L ( 2 )} ( {h}_{18} , {h}_{19} , {h}_{20} , {h}_{21} )$$

Or more generically as:

$${L}_{L ( j )} ( χ ) \approx {\sum }_{{h}_{stutter 1} = 1}^{{T}_{d}} {\sum }_{{h}_{stutter 1} = 1}^{{T}_{d}} {f}_{L ( j )} ( {h}_{stutter 1} , {h}_{allele 1} , {h}_{stutter 2} , {h}_{allele 2} )$$

Possible Case Five—h₁₈ [symbol] T_{d},h₁₉≧T_{d},h₂₀ [symbol] T_{d},h₂₁ [symbol] T_{d}

We need three integrations.

L_{L(2)}(χ)=∫₀^{T}^{_{d}}∫₀^{T}^{_{d}}∫ₕ_{₂₀}^{T}^{_{d}}f_{L(2)}(h₁₈,h₁₉,h₂₀,h₂₁)dh₁₈dh₁₉dh₂₀dh₂₁.

The likelihood is approximated with the summations:

$${L}_{L ( 2 )} ( χ ) \approx {\sum }_{{h}_{18} = 1}^{{T}_{d}} {\sum }_{{h}_{20} = 1}^{{T}_{d}} {\sum }_{{h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{stutter 2} = 1}^{{T}_{d}} {\sum }_{{h}_{stutter 2} = 1}^{{T}_{d}} {f}_{L ( j )} ( {h}_{stutter 1} , {h}_{allele 1} , {h}_{stutter 2} , {h}_{allele 2} )$$

Possible Case Six—h₁₈ [symbol] T_{d},h₁₉ [symbol] T_{d},h₂₀≧T_{d},h₂₁≧T_{d}

Two integrations are required.

L_{L(2)}(χ)=∫₀^{T}^{_{d}}∫ₕ_{₁₈}^{T}^{_{d}}f_{L(2)}(h₁₈,h₁₉,h₂₀,h₂₁)dh₁₈dh₁₉.

The likelihood is approximated with the summations:

$${L}_{L ( 2 )} ( χ ) \approx {\sum }_{{h}_{18} = 1}^{{T}_{d}} {\sum }_{{h}_{19} = {h}_{18} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {f}_{L ( j )} ( {h}_{stutter 1} , {h}_{allele 1} , {h}_{stutter 2} , {h}_{allele 2} )$$

Possible Case Seven—h₁₈ [symbol] T_{d},h₁₉ [symbol] T_{d},h₂₀ [symbol] T_{d},h₂₁≧T_{d}

We need three integrations.

L_{L(2)}(χ)=∫₀^{T}^{_{d}}∫ₕ_{₁₈}^{T}^{_{d}}∫₀^{T}^{_{d}}f_{L(2)}(h₁₈,h₁₉,h₂₀,h₂₁)dh₁₈dh₁₉dh₂₀.

The likelihood is approximated with the summations:

$${L}_{L ( 2 )} ( χ ) \approx {\sum }_{{h}_{18} = 0}^{{T}_{d}} {\sum }_{{h}_{19} = {h}_{18} + 1}^{{T}_{d}} {\sum }_{{h}_{20} = 0}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 0}^{{T}_{d}} {\sum }_{{h}_{sllele 1} = {h}_{stutter 1} + 1}^{{T}_{d}} {\sum }_{{h}_{stutter 1} = 0}^{{T}_{d}} {f}_{L ( j )} ( {h}_{stutter 1} , {h}_{allele 1} , {h}_{stutter 2} , {h}_{allele 2} )$$

Possible Case Eight—h₁₈ [symbol] T_{d},h₁₉ [symbol] T_{d},h₂₀ [symbol] T_{d},h₂₁ [symbol] T_{d}

We need four integrations.

L_{L(2)}(χ)=∫₀^{T}^{_{d}}∫ₕ_{₁₈}^{T}^{_{d}}∫₀^{T}^{_{d}}∫ₕ_{₂₀}^{T}^{_{d}}f_{L(2)}(h₁₈,h₁₉,h₂₀,h₂₁)dh₁₈dh₁₉dh₂₀dh₂₁

The likelihood can be approximated with the summations:

$${L}_{L ( 2 )} ( χ ) \approx {\sum }_{{h}_{18} = 1}^{{T}_{d}} {\sum }_{{h}_{19} = {h}_{18} + 1}^{{T}_{d}} {\sum }_{{h}_{20} = 1}^{{T}_{d}} {\sum }_{{h}_{21} = {h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {\sum }_{{h}_{stutter 1} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 1} , {h}_{stutter 2} , {h}_{allele 2} )$$

3.3.3—Category 3: Heterozygous Donor with Adjacent Alleles

### 3.3.3.1—Stutter

FIG. 4a illustrates an example of such a situation. The example has a profile, c_{L(1)}={h₁₅,h₁₆,h₁₇} arising from a genotype g_{L(1)}={16,17} where each height hᵢ can be smaller than the limit-of-detection threshold T_{d}, situation hᵢ [symbol] T_{d}, or can be greater than this threshold, hᵢ≧T_{d} for i ∈ {15,16,17}. The consideration is of a donor which is heterozygous, but with overlap in position between allele peak and stutter peak.

The position can be stated in the Bayesian Network of FIG. 4b. The stutter peak height for allele 15, H_{stutter,15}, is dependent upon the allele peak height for allele 16, H_{allele,16}, which is in turn dependent upon the DNA quantity, χ. The stutter peak height for allele 16, H_{stutter,16}, is dependent upon the allele peak height for allele 17, H_{allele,17}, which is in turn dependent upon the DNA quantity, χ. Additionally, the Bayesian Network needs to include the combined allele and stutter peak at allele 16, H_{allele+stutter 16}, which is dependent upon the allele peak height for allele 16, H_{allele,16}, and is dependent upon the stutter peak height for allele 16, H_{stutter,16}.

In terms of the actual observed results, H_{stutter,15}, H_{allele,17}, and H_{allele+stutter 16}, are observed and can be seen in FIG. 4a, but H_{allele,16}, and H_{stutter,16} are components within H_{allele-stutter 16} and so are not observed.

In addition, the Bayesian Network of FIG. 4b indicates that both the allele peak height for allele 16, H_{allele,16}, and the allele peak height for allele 17, H_{allele,17}, are dependent upon the heterozygous imbalance, R and the mean peak height, M, with those terms also dependent upon each other and upon the DNA quantity, χ.

In this context, χ, is assumed to be a known quantity.

The overlap between stutter and allele contribution within a peak means that a different approach to obtaining the PDF's needs to be taken.

3.3.3.2—PDF for Allele+Stutter Peak Height with Allele Peak Height and Stutter Peak Height—Details

The PDF for f(hₐₗₗₑₗₑ₁₋ₛₜᵤₜₜₑᵣ₁|hₐₗₗₑₗₑ₁,hₛₜᵤₜₜₑᵣ₁)=1 if hₐₗₗₑₗₑ₁₌ₛₜᵤₜₜₑᵣ₁=hₐₗₗₑₗₑ₁+hₛₜᵤₜₜₑᵣ₁ and has value=0 otherwise. This is more clearly seen in the two specific examples:

f(h_{=200 for allele1+stutter1}|h_{=150 for allele1},h_{=50 for stutter1})=1

f(h_{=210 for allele1+stutter1}|h_{=150 for allele1},h_{=50 for stutter1})=0

This form is used to provide a PDF for H_{allele+stutter 16} in the above example.

### 3.3.3.3—PDF's for Other Observed Peaks

The PDF's for the other two observed dependents are obtained by integrating out H_{allele,16}, and H_{stutter,16} in the above example; more generically, Hₐₗₗₑₗₑ₁, and Hₛₜᵤₜₜₑᵣ₁. Integrating out avoids the need to consider a three dimensional estimation of the PDF's from experimental data.

The integrating out allows PDF's for the resulting components to be sought, for instance by looking at all the possibilities. This provides:

f(hₐₗₗₑₗₑ₁₆,hₐₗₗₑₗₑ₁₇|χ)×f(hₛₜᵤₜₜₑᵣ₁₅|hₐₗₗₑₗₑ₁₆)×f(hₛₜᵤₜₜₑᵣ₁₆|hₐₗₗₑₗₑ₁₇)×f(hₐₗₗₑₗₑ₊ₛₜᵤₜₜₑᵣ₁₆|hₐₗₗₑₗₑ₁₆,hₛₜᵤₜₜₑᵣ₁₆)

Which equates to:

f(hₐₗₗₑₗₑ₁₆,hₐₗₗₑₗₑ₁₇|χ)×f(hₛₜᵤₜₜₑᵣ₁₅,hₐₗₗₑₗₑ₁₆,hₛₜᵤₜₜₑᵣ₁₆,hₐₗₗₑₗₑ₊ₛₜᵤₜₜₑᵣ₁₆,hₐₗₗₑₗₑ₁₇)

This comes together as the simplified Bayesian Network of FIG. 4c. In an example where locus 1 is under consideration and the allele peaks are at 16 and 17 and the stutter peaks are at 15 and 16, we wish to calculate:

L_{L(1)}(χ)=f(c_{L(1)}|g_{L(1)},V,χ)

So, without considering T_{d}, the generic PDF is defined as:

f_{L(1)}(h₁₅,h₁₆,h₁₇)=∫_{R}fₛ(h₁₅|h_{a,16})fₛ(h_{s,16}|h₁₇)fₕₑₜ(h_{a,16},h₁₇)dh_{a,16}dh_{s,16}

where R={hₐ₁₆,h_{s,16}:h_{a,16}+h_{s,16}=h₁₆}; fₛ is PDF for stutter heights conditional on parent height; and fₕₑₜ is a PDF of pairs of heights of heterozygous genotypes. The PDFs in these sections are given for any value hᵢ, including hᵢ less than the threshold T_{d}.

The integral in the equation above can be computed by numerical integration or Monte Carlo integration. The preferred method for numerical integration is adaptive quadratures. The simplest method is integration by hitogram approximation, which, for completeness, is given below.

The integral in the previous equation can be approximated with the summation:

$${f}_{L ( 1 )} ( {h}_{15} , {h}_{16} , {h}_{17} ) \approx {\sum }_{{h}_{a , 16} = {h}_{15} + 1}^{{h}_{16}} {f}_{s} ( {h}_{15} \vert {h}_{a , 16} ) {f}_{s} ( {h}_{s , 16} \vert {h}_{17} ) {f}_{het} ( {h}_{a , 16} , {h}_{17} )$$

where h_{s,16}=h₁₆−h_{a,16}. The step in the summation is one. It can be modified to have a larger increment, say x_{inc}, but then the term in the summation needs to be multiplied by x_{inc}. This is one possible numerical approximation. Faster numerical integrations can be achieved using adaptive methods in which the size of the bin is dynamically selected.

### 3.3.3.4—Extending to Dropout

The term f_{L(1)}(h₁₅,h₁₆,h₁₇) provides density values for each value of the arguments. However, in many occasions technical dropout has occurred, that is, a peak is smaller than the limit-of-detection threshold T_{d}. In this case we need to calculate further integral to obtain the required likelihoods. In the following sections we describe the extra calculations that need to be done for each of the six possible cases.

All integrals described in the sections below can be computed by numerical integration of Monte Carlo integration. The method described in these sections in the simplest way to compute a numerical integration through a hitogram approximation. They are included for the sale of completeness. An integration method based on adaptive quadratures is more efficient in terms of computational cost.

Possible Case One—h₁₅≧T_{d},h₁₆≧T_{d},h₁₇≧T_{d}

If all the heights in c_{L(1)} are taller than T_{d} then the numerator of the LR for this locus is given by:

L_{L(1)}(χ)=f_{L(1)}(h₁₅,h₁₆,h₁₇).

Or more generically:

L_{L(j)}(χ)=f_{L(j)}(hₛₜᵤₜₜₑᵣ₁,hₐₗₗₑₗₑ₁₊ₛₜᵤₜₜₑᵣ₂,hₐₗₗₑₗₑ₂)

Possible Case Two—h₁₅ [symbol] T_{d},h₁₆≧T_{d},h₁₇≧T_{d}

If one of the heights are below T_{d} we need to perform further integrations. For example if h₁₅ [symbol] T_{d} the numerator of the LR is given by the equation:

L_{L(1)}(χ)=∫ₕ_{₁₅} [symbol] ₕ_{₁₆}f_{L(1)}(h₁₅,h₁₆,h₁₇)dh₁₅.

A numerical approximation can be use to obtain the integral:

$${L}_{L ( 1 )} ( χ ) = {\sum }_{{h}_{15} = 1}^{{T}_{d}} {f}_{L ( 1 )} ( {h}_{15} , {h}_{16} , {h}_{17} ) .$$

Or more generically:

$${L}_{L ( j )} ( χ ) = {\sum }_{{h}_{stutter 1} = 1}^{{T}_{d}} {f}_{L ( j )} ( {h}_{stutter 1} , {h}_{allele 1 + stutter 2} , {h}_{allele 2} )$$

Possible Case Three—h₁₅ [symbol] T_{d},h₁₆ [symbol] T_{d},h₁₇≧T_{d}

In this case we need to compute two integrals:

L_{L(1)}(χ)=∫ₕ_{₁₅} [symbol] _{T}_{_{d}}∫ₕ_{₁₆} [symbol] _{T}_{_{d}}f_{L(1)}(h₁₅,h₁₆,h₁₇)dh₁₅.

It can be approximated with:

$${L}_{L ( 1 )} ( χ ) \approx {\sum }_{{h}_{15} = 1}^{{T}_{d}} {\sum }_{{h}_{16} = {h}_{15 + 1}}^{{T}_{d}} {f}_{L ( 1 )} ( {h}_{15 ,} {h}_{16} , {h}_{17} ) d {h}_{15} d {h}_{16} .$$

Or more generically by:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {f}_{L ( j )} ( {h}_{stutter 1} , {h}_{allele 1 + stutter 2} , {h}_{stutter 2} ) d {h}_{stutter 1} d {h}_{allele 1 + stutter 2}$$

Possible Case Four—h₁₅ [symbol] T_{d},h₁₆≧T_{d},h₁₇ [symbol] T_{d}

In this case we need to calculate two integrals:

L_{L(1)}(χ)=∫ₕ_{₁₅} [symbol] _{T}_{_{d}}∫ₕ_{₁₇} [symbol] _{T}_{_{d}}f_{L(1)}(h₁₅,h₁₆,h₁₇)dh₁₅dh₁₇.

It can be approximated by

$${L}_{L ( 1 )} ( χ ) \approx {\sum }_{{h}_{15} = 1}^{{T}_{d}} {\sum }_{{h}_{17} = 1}^{{T}_{d}} {f}_{L ( 1 )} ( {h}_{15} , {h}_{16} , {h}_{17} )$$

Or more generically by:

$${L}_{L ( i )} ( χ ) \approx {\sum }_{{h}_{stutter 1} = 1}^{{T}_{d}} {\sum }_{{h}_{allele 2} = 1}^{{T}_{d}} {f}_{L ( j )} ( {h}_{stutter 1} , {h}_{allele 1 + stutter 2} , {h}_{allele 2} )$$

Possible Case Five—h₁₅≧T_{d},h₁₆≧T_{d},h₁₇ [symbol] T_{d}

In this case we need to calculate only one integral:

L_{L(1)}(χ)=∫ₕ_{₁₇} [symbol] _{T}_{_{d}}f_{L(1)}(h₁₅,h₁₆,h₁₇)dh₁₇.

The integral can be approximated using the summation:

$${L}_{L ( 1 )} ( χ ) \approx {\sum }_{{h}_{17} = 1}^{{T}_{d}} {f}_{L ( 1 )} ( {h}_{15} , {h}_{16} , {h}_{17} )$$

Or more generically by:

$${L}_{L ( j )} ( χ ) \approx {\sum }_{{h}_{allele 2} = 1}^{{T}_{d}} {f}_{L ( j )} ( {h}_{stutter 1} , {h}_{allele 1 + stutter 2} , {h}_{stutter 2} )$$

Possible Case Six—h₁₅ [symbol] T_{d},h₁₆ [symbol] T_{d},h₁₇ [symbol] T_{d}

In this case we need to compute three integrals:

L_{L(1)}(χ)=∫ₕ_{_{—}}₁₅ [symbol] _{T}_{_{d}}∫ₕ_{_{—}}₁₆ [symbol] _{T}_{_{d}}∫ₕ_{_{—}}₁₇ [symbol] _{T}_{_{d}}f_{L(1)}(h₁₅,h₁₆,h₁₇)dh₁₅dh₁₆dh₁₇.

The integrals can be approximate with the summations,

$${L}_{L ( 1 )} ( χ ) \approx {\sum }_{{h}_{15} = 1}^{{T}_{d}} {\sum }_{{h}_{16} = {h}_{15} + 1}^{{T}_{d}} {\sum }_{{h}_{17}}^{{T}_{d}} {f}_{L ( 1 )} ( {h}_{15} , {h}_{16} , {h}_{17} )$$

Or more generically:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {\sum }_{{h}_{allele 2}}^{{T}_{d}} {f}_{L ( j )} ( {h}_{stutter 1} , {h}_{allele + stutter 2} , {h}_{allele 2} )$$

### 3.3.4—LR Nominator Summary

The approach for the three different categories is summarised in the Bayesian Network of FIG. 5. This presents the acyclic directed graph of a Bayesian Network in the case of three loci with the form:
Locus L(1):
   c_{L(1)}={h₁₅,h₁₆,h₁₇} and
   g_{s,L(1)}={16,17}
Locus L(2):
   c_{L(2)}={h₁₈,h₁₉,h₂₀,h₂₁} and
   g_{s,L(2)}={19,20}
Locus L(3):
   c_{L(3)}={h₁₀,h₁₁} and
   g_{s,L(3)}={11,11}

The specification of the calculation of likelihood for this Bayesian Network is sufficient for calculating likelihoods for all loci of any number of loci.

### 3.4 The LR Denominator Form

The calculation of the denominator follows the same derivation approach. Hence, the calculation of the denominator is given by:

L_{d}=f(c|gₛ,V_{d})

As above, because the crime profile c extends across loci, for the three locus example, the initial equation of this section can be rewritten as:

L_{d}=f(c_{L(1)},c_{L(2)},c_{L(3)}|g_{s,L(1)},g_{s,L(2)},g_{s,L(3)},V_{d})

Likelihood L_{d} can be factorised according to DNA quantity and combined with the previous equation's expansion, to give:

$${L}_{d} = {\sum }_{{χ}_{i}} f ( {c}_{L ( 1 )} \vert {g}_{L ( 1 )} , {V}_{d} , {χ}_{i} ) f ( {c}_{L ( 2 )} \vert {g}_{L ( 2 )} , {V}_{d} {χ}_{i} ) f ( {c}_{L ( 3 )} \vert {g}_{L ( 3 )} , {V}_{d} {χ}_{i} )$$

This can be abstracted to give:

f(c_{L(j)}|g_{L(j)},V_{d},χᵢ)

As the expression f(c_{L(j)}|g_{L(j)},V_{d},χᵢ) does not specify the donor of the crime stain, it needs to be expanded as:

$$f ( {c}_{L ( j )} \vert {g}_{L ( j )} , {V}_{d} , {χ}_{i} ) = {\sum }_{{g}_{U , L ( j )}} f ( {c}_{L ( j )} {g}_{U , L ( j )} , {V}_{d} , χ \vert ) \times p ( {g}_{U , L ( j )} \vert {g}_{S , L ( j )} , {V}_{d} )$$

The first term on the right hand side of this definition corresponds to a term of matching form found in the numerator, as discussed above and expressed as:

L_{L(j)}(χ)=f(c_{L(j)|}g_{L(j)},V,χ)

The second term in the right-hand side is a conditional genotype probability. This can be computed using existing formula for conditional genotype probabilities given putative related and unrelated contributors with population structure or not, for instance see J. D. Balding and R. Nichols. DNA profile match probability calculation: How to allow for population stratification, relatedness, database selection and single bands. Forensic Science International, 64:125-140, 1994.

We denote the first term with the expression:

L_{d,L(j)}(χ)=f(c_{L(j)}|g_{U,L(j)},V_{d},χ)

with the likelihood in this specified as a likelihood of the heights in the crime profile given the genotype of a putative donor, and so, they can be written as:

L_{L(j)}(χ)=f(c_{L(j)}|g_{L(j)},V,χ),

where V states that the genotype of the donor of crime profile c_{L(j)} is g_{L(j)}.

The Bayesian Network for calculating the denominator of the likelihood ratio is shown in FIG. 5. The network is conditional on the defence hypothesis V_{d}. The ovals represent probabilistic quantities whilst the rectangles represent known quantities. The arrows represent probabilistic dependencies.

In general terms, the denominator can be stated as:

$${\sum }_{{χ}_{i}} [ {Π}_{j}^{n loci} \sum f ( {c}_{L ( j )} \vert {g}_{u , L ( j )} , {V}_{d} , {χ}_{i} ) \times p ( {g}_{u , L ( j )} \vert {g}_{s , L ( j )} ) ] p ( {χ}_{i} )$$

where the consideration is in effect, the genotype (gₛ) is the donor of (cₕ₍ⱼ₎) given the DNA quantity (χᵢ).

The general statements provided above for the denominator enable a suitable denominator to be established for the number of loci under consideration.

### 3.5—The LR Denominator Quantification

In the denominator of the LR we need to calculate the likelihood of observing a set of heights giving any potential contributors. Most of the likelihoods would return a zero, if there is a height that is not explained by the putative unknown contributor. The presence of a likelihood of zero as the denominator in the LR would be detrimental to the usefulness of the LR.

In this section we provide with a method for generating genotype of unknown contributors that will lead to a non-zero likelihood.

For c_{L(i)} there may be a requirement to augment with zeros to account for peaks that are smaller than the limit-of-detection threshold T_{d}. It is assumed that the height of a stutter is at most the height of the parent allele.

The various possible cases observed from a single unknown contributor are now considered. In the generic definitions, the allele number, stated as allele1, allele 2 etc refers to the sequence in the size ordered set of alleles, in ascending size.

### Possible Case 1—Four Peaks

For this to be a single profile we need the two pair of heights where each pair are adjacent. If the heights are c_{L(i)}={h₁,h₂,h₃,h₄}, then the only possible genotype of the contributor is g_{U}={2,4}. Crime profile c_{L(i)} remains unchanged.

Possible Case 2—Three Peaks with One Allele Not Adjacent

In this cases, there are two sub-cases to consider:
The larger two peaks are adjacent. If the peak heights are c_{L(i)}={h₂,h₅,h₆}, then the only possible genotype is g_{U},_{L(i)}={2,6} and c_{L(i)}={h₁,h₂,h₅,h₆} where h₁=0.
The smaller two peaks are adjacent. If the peak heights are {h₂,h₃,h₅}, the only possible genotype is g_{U}={3,5} and c_{L(i)}={h₂,h₃,h₄,h₅} where h₄=0.

### Possible Case 3—Three Adjacent Peaks

The alleles heights can be written as c_{L(i)}={h₂,h₃,h₄}. There are only two sub-cases to consider:

g_{U},_{L(i)}={2,4} or

g_{U},_{L(i)}={3,4}.
If g_{U},_{L(i)}={2,4}, then c_{L(i)}={h₁,h₂,h₃,h₄} where h₁=0.
If g_{U},_{L(i)}={3,4}, then c_{L(i)} remains unchanged.

### Possible Case 4—Two Non-Adjacent Peaks

If allele heights are c_{L(i)}={h₂,h₄}, then the only possible genotype is g_{U},_{L(i)}={2,4} and c_{L(i)}={h₁,h₂,h₃,h₄} where h₁=0 and h3=0.

### Possible Case 5—Two Adjacent Peaks

If allele heights are c_{L(i)}={h₂,h₃} then four possible genotypes need to be considered:

g_{U},_{L(i)}={2,3}

g_{U},_{L(i)}={3,3}

g_{U},_{L(i)}={3,4} or

g_{U},_{L(i)}={3,Q}
where Q is any other allele different than alleles 2, 3 and 4.
if g_{U},_{L(i)}={2,3}, then c_{L(i)}={h₁,h₂,h₃} where h₁=0
if g_{U},_{L(i)}={3,3}, then c_{L(i)}={h₂,h₃} remains unchanged
if g_{U},_{L(i)}={3,4}, then c_{L(i)}={h₂,h₃,h₄} where h₄=0
if g_{U},_{L(i)}={3,Q}, then c_{L(i)}={h₂,h₃,h_{s,Q},h_{Q}} where h_{s,Q}=h_{Q}=0.

### Possible Case 6—One Peak

If the peak is denoted by c_{L(i)}={h₂}, then three possible genotypes need to be considered:

g_{U},_{L(i)}={2,2}

g_{U},_{L(i)}={2,3} or

g_{U},_{L(i)}={2,Q}
where Q is any allele other than 2 and 3.
if g_{U},_{L(i)}={2,2}, then c_{L(i)}={h₁,h₂} where h₁=0
if g_{U},_{L(i)}={2,3}, then c_{L(i)}={h₁,h₂,h₃} where h₁=h₃=0
if g_{U},_{L(i)}={2,Q}, then c_{L(i)}={h₁,h₂,h_{s,Q},h_{Q}} where h₁=h_{s,Q}=h_{Q}=0.

### Possible Case 7—No Peak

If this case the LR is one and therefore, there is no need to compute anything.

### 4. DETAILED DESCRIPTION—MIXED PROFILE

### 4.1—The Calculation of the LR

The aim of this section is to describe in detail the statistical model for computing likelihood ratios for mixed profiles while considering peak heights, allelic dropout and stutters.

In considering mixtures, there are various hypotheses which are considered. These can be broadly grouped as follows:

Prosecution hypotheses:
Vₚ(S+V): The DNA came from the suspect and the victim;
Vₚ(S₁+S₂): The DNA came from suspect 1 and suspect 2;
Vₚ(S+U): The DNA came from the suspect and an unknown contributor;
Vₚ(V+U): The DNA came from the victim and an unknown contributor.

Defence hypotheses:
V_{d}(S+U): The DNA came from the suspect and an unknown contributor;
V_{d}(V+U): The DNA came from the victim and an unknown contributor;
V_{d}(U+U): The DNA came from two unknown contributors.

The combinations that are used in casework are:
Vₚ(S+V) and V_{d}(S+U);
Vₚ(S+V) and V_{d}(V+U);
Vₚ(S+U) and V_{d}(U+U);
Vₚ(V+U) and V_{d}(U+U);
Vₚ(S₁+S₂) and V_{d}(U+U).

If we denote by K₁ and K₂ the person whose genotypes are known, there are only three generic pairs of propositions:
Vₚ(K₁+K₂) and V_{d}(K₁+U);
Vₚ(K₁+U) and V_{d}(U+U);
Vₚ(K₁+K₂) and V_{d}(U+U).

The likelihood ratio (LR) is the ratio of the likelihood for the prosecution hypotheses to the likelihood for the defence hypotheses. In this section, that means the LR's for the three generic combinations of prosecution and defence hypotheses listed above.

Throughout this section p(w) denotes a discrete probability distribution for mixing proportion w and p(x) denotes a discrete probability distribution for x.

### 4.4.1—Proposition One—Vₚ(K₁+K₂) and V_{d}(K₁+U)

The numerator of the LR is:

$$num = {\sum }_{x} {\sum }_{w} {\prod }_{i}^{n loci} f ( {C}_{L ( i )} \vert g 1 , L ( i ) , g 2 , {L}_{( i )} , w , x ) p ( w ) p ( x )$$

where:
g₁ and g₂ are the genotypes of the known contributors K₁ and K₂ across loci;
c. is the crime profile across loci;
The subscript L(i) means that the either the genotype of crime profile is for locus i or n_{loci} is the number of loci.

The denominator of the LR is:

$$den = {\sum }_{x} {\sum }_{w} {\prod }_{i}^{n loci} {\sum }_{gU , L ( i )} f ( {C}_{L ( i )} \vert {g}_{1} , L ( i ) , gU , L ( i ) , w , x ) p ( gU , L ( i ) \vert {g}_{1} , L ( i ) , {g}_{2} , L ( i ) ) p ( w ) p ( x )$$

where:
g1,L(i) is the genotype of the known contributor in locus I;
g2,L(i) is a known genotype for locus i but it is not proposed as a genotype of the donor of the mixture;
gU,L(i) is the genotype of the unknown donor.

The conditional genotype probability in the right-hand-side of the equation is calculated using the Balding and Nichols model cited above.

The function in the left-hand side equation is calculated from probability distribution functions of the type described above and below.

### 4.4.2—Proposition Two—Vₚ(K₁+U) and V_{d}(U+U)

The numerator is:

$$num = {\sum }_{x} {\sum }_{w} {\prod }_{i}^{n loci} {\sum }_{gU , L ( i )} f ( {C}_{L ( i )} \vert {g}_{1} , {L}_{i} , gu , {L}_{( i )} , w , x ) p ( gu , L ( i ) \vert g 1 , L ( i ) ) p ( w ) p ( x )$$

where:
g1,L(i) is the genotype of the known contributor K₁ in locus i.

The denominator is

$$den = {\sum }_{x} {\sum }_{w} {\prod }_{i}^{{n}_{Loci}} {\sum }_{{g}_{{U}_{1} , L ( i )} , {g}_{{U}_{2} , L ( i )}} f ( {c}_{L ( i )} \vert {g}_{{U}_{1} , L ( i )} , {g}_{{U}_{2} , L ( i )} , w , x ) p ( {g}_{{U}_{1} , L ( i )} , {g}_{{U}_{2} , L ( i )} \vert {g}_{1 , L ( i )} , {g}_{2} , L ( i ) ) p ( w ) p ( x )$$

where:
g1,L(i) is the genotype of the known contributor K₁ in locus i; and
g_{U1},L(i) and g_{U2},L(i) are the genotypes for locus i of the unknown contributors.

The second factor is computed as:

p(g_{U}_{₁}_{,Λ(i)},g_{U}_{₂}_{,Λ(i)}|g_{1,Λ(i)})=p(g_{U}_{₁}_{,Λ(i)}|g_{1,Λ(i)},g_{U}_{₂}_{,Λ(i)})p(g_{U}_{₂}_{,Λ(i)}|g_{1,Λ(i)})

The factors in the right-hand-side of the equation are computed using the model of Balding and Nichols cited above.

### 4.4.3—Proposition Three—Vₚ(K₁+K₂) and V_{d}(U+U)

The numerator is the same as the numerator for the first generic pair of hypotheses. The denominator is almost the same as the denominator for the second generic pair of propositions except for the genotypes to the right of the conditioning bar in the conditional genotype probabilities. The denominator of the LR for the generic pair of propositions in this section is:

$$den = {\sum }_{x} {\sum }_{w} {\prod }_{i}^{{n}_{Loci}} {\sum }_{{g}_{{U}_{1} , Λ ( i )} , {g}_{{U}_{2} , Λ ( i )}} f ( {c}_{Λ ( i )} \vert {g}_{{U}_{1} , Λ ( i )} , {g}_{{U}_{2} , Λ ( i )} , w , x ) p ( {g}_{{U}_{1} , Λ ( i )} , {g}_{{U}_{2} , Λ ( i )} \vert {g}_{1 , Λ ( i )} , {g}_{2 , Λ ( i )} ) p ( w ) p ( x )$$

where:
g1,L(i) and g2,L(i) are the genotypes of the known contributors K₁ and K₂ in locus i;
gU₁,L(i) and gU₂,L(i) are the genotypes for locus i of the unknown contributors.

The second factor is computed as:

p(g_{U}_{₁}_{,Λ(i)},g_{U}_{₂}_{,Λ(i)}|g_{1,Λ(i)},g_{2,Λ(i)})=p(g_{U}_{₁}_{,Λ(i)}|g_{1,Λ(i)},g_{2,Λ(i)},g_{U}_{₂},Λ(i))p(g_{U}_{₂}_{,Λ(i)}|g_{1,Λ(i)}, g_{2,Λ(i)})

The factors in the right-hand-side of the equation are computed using the model of Balding and Nichols cited above.

### 4.2—Density Value for Crime Profile Given Two Putative Donors

The terms in the calculations above are put together using per locus conditional genotype probabilities and density values of per locus crime profiles given putative per locus genotypes of two contributors. The conditional genotype probabilities are calculated using the model of Balding and Nichols cited above. In this section we focus on the density values of per locus crime profiles.

For the sake of clarity and brevity of explanation, the method for calculating the density value f(cL(i)|g1,L(i),g2,L(i),w,x) is explained through an example.

### EXAMPLE

The genotypes and crime profiles are:

g_{1,Λ(i)}={16,17}

g_{2,Λ(i)}={18,20}

c_{Λ(i)}={h*_{,15},h*_{,16},h*_{,17},h*_{,18},h*_{,19},h*_{,20}}.

We first obtain an intermediate probability density function (PDF) defined as the product of the factors:

f(h_{1,15},h_{1,16},h_{1,17}|g_{1,Λ(i)}={16,17},w×x) 1.

f(h_{2,17},h_{2,18},h_{2,19}|g_{2,Λ(i)}={18,28},(1−w)×x) 2.

δ_{S}(h₁₇|h_{1,17},h_{2,17})

The first factor has been already defined as a PDF for a single contributor: in this case the donor is g1,L(i)={16,17} and DNA quantity w×x. The second factor has also being defined as a PDF for a single contributor: the donor in this case is g2,L(i)={18,28} and DNA quantity (1−w)×x. The third factor is a degenerated PDF defined by: δ_{S}(h₁₇|h_{1,17},h_{2,17})=1 if h_{1,17}+h_{2,17} and zero otherwise. The intermediate PDF is denoted by f(h_{1,15},h_{1,16},h_{1,17},h₁₇,h_{2,17},h_{2,18},h_{2,19}). The required density value is obtained by integration:

f(h*_{,15},h*_{,16},h*_{,17},h*_{,18},h*_{,19})=∫f(h*_{,15},h*_{,16},h_{1,17}, h*_{,17},h_{2,17},h*_{,18},h*_{,19})dh_{1,17}dh_{2,17}

where f(h*_{,15},h*_{,16},h*_{,17},h*_{,18},h*_{,19})=f(c_{Λ(i)}|g_{1,Λ(i)},g_{2,Λ(i)},w,x) in this example.

Notice that h_{1,15} has been replaced by the observed height in the crime profile h*_{,15}. This is because h_{1,15} represents a generic variable and h*_{,15} represent an observed height. (For example, cosine(y) represents a generic function but cosine(π) represent the evaluation of the function cosine for the value π.). Notice as well that the height h*,15 is only explained by the stutter of allele 16.

In contrast, h_{1,17} and h_{2,17} are not replaced by h*_{,17} because h*_{,17} is form as the sum of h_{1,17} and h_{2,17}. We do not know the observed values but only the sum of them. (If we observe number 10 and we are told that it is the sum of two numbers, there are many possibilities for the two numbers: 1 and 9, 2 and 8, 1.1 and 8.9, etc.). The integration considers all of the possible h_{1,17} and h_{2,17}. The variable that take these values is known as a hidden, latent or unobserved variable.

The integration can be achieved using any type of integration, including, but not limited to, Monte Carlo integration, and numerical integration. The preferred method is adaptive numerical integration in one dimension in this example, and in several dimensions in general.

The general methods is to generate an intermediate PDF using the PDF of the contributor and by introducing δₛ PDFs for the height pairs that fall in the same position. There can be cases when more than one pair of heights fall in the same position. For example if g1,L(i)={16,17} and g2,L(i)={16,17}, then there are three pairs of heights falling in the same position: one in position 15, another in position 16 and the third in position 17.

If one of the observed heights is below the limit-of-detection threshold T_{d}, we need to perform further integration to consider all values. For example if h{*,15} is reported as below the limit-of-detection threshold T_{d} and all other heights are greater than the limit-of-detection threshold, the PDF value that we are interested become a likelihood given by:

f(h*_{,15}<T_{d},h*_{,16},h*_{,17},h*_{,18},h*_{,19})=∫ₕ*_{,15}_{^{<T}}_{d}f(h₁₅,h*_{,16},h*_{,17},h*_{,18},h*_{,19})dh₁₅

The integral consider all the possibilities for h₁₅. In general we need to perform an integration for each height that is smaller than T_{d}. Any method for calculating the integral can be used. The preferred method is adaptive numerical integration.

### 5 DETAILED DESCRIPTION—INTELLIGENCE USES

### 5.1—Use in Intelligence Applications

In an intelligence context, a different issue is under consideration to that approached in an evidential context. The intelligence context seeks to find links between a DNA profile from a crime scene sample and profiles stored in a database, such as The National DNA Database® which is used in the UK. The process is interested in the genotype given the collected profile.

Thus in this context, the process starts with a crime profile c, with the crime profile consisting of a set of crime profiles, where each member of the set is the crime profile of a particular locus. The method is interested in proposing, as its output, a list of suspect's profiles from the database. Ideally, the method also provides a posterior probability (to observing the crime profile) for each suspect's profile. This allows the list of suspect's profiles to be ranked such that the first profile in the list is the genotype of the most likely donor.

Where the profile is from a single source, a single suspect's profile and posterior probability is generated.

Where the profile is from two sources, a pair of suspect profiles and a posterior probability are generated.

### 5.2—Intelligence Application—Single Profile

As described above, the process starts with a crime profile c, with the crime profile consisting of a set of crime profiles, where each member of the set is the crime profile of a particular locus. The method is interested in proposing a list of single suspect profiles from the database, together with a posterior probability for that profile. This task is usually done by proposing a list of genotypes {g₁,g₂, . . . , gₘ} which are then ranked according the posterior probability of the genotype given the crime profile.

The list of genotypes is generated from the crime scene c. For example if c={h₁,h₂}, where both h₁ and h₂ are greater than the dropout threshold, t_{d}, then the potential donor genotype is generated according to the scenarios described previously. Thus, if the peaks are not adjoining, then the lower size peak is not a possible stutter and g={1,2}. If the peaks are adjoining, then g={1, 2} and g={stutter2, 2} are possible, and so on.

The quantity to be computed is the posterior probability, p(gᵢ|c), for all possible genotypes across the profile, gᵢ. This quantity can be defined as:

$$p ( {g}_{i} \vert c ) = \frac{f ( c \vert {g}_{i} ) p ( {g}_{i} )}{{\sum }_{{g}_{j}} f ( c \vert {g}_{j} ) p ( {g}_{j} )}$$

where p(gᵢ) is a prior distribution for genotype gᵢ, preferably computed from the population in question.

The likelihood f(c|g) can be computed using the approach of section 3.2 above, but with the modification of replacing the suspect's genotype by one of the generated gᵢ.

Thus the computation uses:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

Where L_{p,L(j)}(χᵢ) is the likelihood for locus j conditional on DNA quantity, this assumes the abstracted form:

L_{p,L(j)}(χ)=f(c_{L(j)}|g_{s,L(j)},Vₚ,χⱼ)

or:

L_{p,L(j)}(χ)=f(c_{L(j)}|gₕ₍ⱼ₎,V,χⱼ).

or:

$${\sum }_{{χ}_{i}} [ {Π}_{j}^{n loci} f ( {c}_{h ( j )} \vert {g}_{s , L ( j )} , {V}_{p} , {χ}_{i} ) ] p ( {χ}_{i} )$$

The prior probability p(gᵢ|c) is computed as:

p(gᵢ)=Πₖ₌₁ⁿ^{_{loci}}p(g_{i,L(k)})

Each factor in this product can be computed using the following approach. The approach inputs are:
g—a genotype;
AlleleList—a list of observed alleles—this may include allele repetitions, such as {15,16;15,16};
locus—an identifier for the locus;
theta—a co-ancestry or inbreeding coefficient—a real number in the interval [0,1];
eaGroup—ethnic appearance group—an identifier for the ethnic group appearance, which can change from country to country;
alleleCountArray—an array of integers containing counts corresponding to a list of alleles and loci.

The approach outputs are:
Prob—a probability—a real number with interval [0,1].

The algorithmical description becomes:
m) if g is a heterozygote, then multiply by 2;
n) N=length(g)+length(allelelist);
o) den=[1+(N−2)θ][1+(N−3)θ];
p) n₁ is the number of times that the first allele g(1) is present in allelelist ∪ g(2);
q) n₂ is the number of times that the second allele g(2) is present in the list alleleList.
r) num=[(n₁−1)θ+(1−θ)*p₁][(n₂−1)θ+(1−θ)*p₂] where p₁ is the probability of allele g(1) and p₂ is the probability of allele g(2).

### 5.3—Intelligence Application—Mixed Profile

In the mixed profile case, the task is to propose an ordered list of pairs of genotypes g₁ and g₂ per locus (so that the first pair in the list are the most likely donors of the crime stain) for a two source mixture; an ordered list of triplets of genotypes per locus for three source sample, and so on.

The starting point is the crime stain profile c. From this, an exhaustive list {g_{1,i},g_{2,i}} of pairs of potential donors are generated. The potential donor pair genotypes are generated according to the scenarios described previously taking into account possible stutter etc.

For each of theses pairs, a probability distribution for the genotypes is calculated using the formula:

$$p ( {g}_{1} , {g}_{2} \vert c ) = \frac{f ( c \vert {g}_{1} , {g}_{2} ) p ( {g}_{1} , {g}_{2} )}{{\sum }_{gi , gj} f ( c \vert {g}_{i} , {g}_{j} ) p ( {g}_{i} , {g}_{j} )}$$

where p(g₁,g₂) and/or p(gᵢ,gⱼ) are a prior distribution for the pair of genotypes inside the brackets that can be set to a uniform distribution or computed using the formulae introduced by Balding et al.

In practice, there is no need to compute the denominator as the computation extends to all possible genotypes. The term can be normalised later. As described above for evidential uses, for instance, the core term is the calculation of the likelihood f(c|g₁,g₂). This can be computed according to the formula:

$$f ( c \vert {g}_{1} , {g}_{2} ) = {\sum }_{x} {\sum }_{w} {\prod }_{i}^{{n}_{loci}} f ( {c}_{L ( i )} \vert {g}_{1 , L ( i )} , {g}_{2 , L ( i )} ) p ( w ) p ( x )$$

where the term:

$$p ( {g}_{1} , {g}_{2} ) = {\prod }_{i}^{{n}_{loci}} p ( {g}_{1 , L ( i )} \vert {g}_{2 , L ( i )} ) p ( {g}_{1 , L ( i )} )$$

Each factor in this product can be computed using the approach described in section 5.2 above.

### NOTATION AND GLOSSARY

i: A variable used as a sub-script to count over a set.

j: The same as i. Notice that these variables are not attached to a particular aspect. They take a meaning within the context where they are used. E.g. i can denote a locus number in context L(i) and it can denote a particular wvalue of DNA quantity in Xi.

Gₛ: It denotes the possible genotypes that a person can have across loci. The subscript denotes the person that the genotype belongs to. In this case S denotes the suspect's genotype and therefore Gₛ denotes all possible genotypes that the suspect could have.

gs: it denotes a specific genotype that, in this case, the suspect could have.

Gₛ=gs: it reads—the genotype that the suspect has is gs, which is the same as: the suspect's genotype is gs.

Pr(Gₛ=gs): the probability that the suspect's genotype is gs.

p(gs): it is a short version of Pr(Gₛ=gs). It is used when it is not ambiguous.

gs={gs,L(1),gs,L(2), . . . , gs,L_{(nLoci)}}. The suspect's gentotype across profile consists of genotypes per locus.

nLoci: The number of loci in the profile.

gs,L(i): The genotype of the suspect in locus i.

Gs,L(ii={16,17}: the genotype of the suspect is {16, 17} in locus i.

PG_{s,L(i)}({16,17}): it is a short version of Pr(G_{s,L(i)}+{16,17}). In this case we need to add the subscript Gₛ to avoid ambiguity.

Gu: it denotes a specific genotype that, in this case, the putative unknown contributor U could have.

C: all possible profiles in across loci.

c: a specific profile across loci.

C_{L(i)}: all possible profiles in locus i

C_{L(i)}: a specific profile in locus i.

C_{L(i)}={h₁₆,h₁₇,h₁₈}: the profile in locus I is {h₁₆,h₁₇,h₁₈}

hⱼ: the height of a peak in a profile; the subscript denotes the designation of the peak.

X: all possible values that DNA quantity can take.

χ: a specific value that DNA quantity can take.

Pr(X=χ): the probability that the DNA quantity is χ.

P(χ): a short version of Pr(X=χ)

P(χᵢ): although DNA quantity is a continuous quantity, we use a discrete distribution and therefore we use the sub-script i to refer to one of the discrete values.

PDF. Probability density function

LR. Likelihood ratio

BN. Bayesian network

### REFERENCES

J. D. Balding and R. Nichols. DNA profile match probability calculation: How to allow for population stratification, relatedness, databased selection and single bands. Forensic Science International, 64:125-140, 1994.

1. A computer implemented method of comparing a test sample result set with another sample result set, the method including:
providing information for the first result set on the one or more identities detected for a variable characteristic of DNA;
providing information for the second result set on the one or more identities detected for a variable characteristic of DNA; and
comparing at least a part of the first result set with at least a part of the second result set; and wherein:
the comparing includes a likelihood and the likelihood uses a probability density function conditioned on DNA quantity.

2. A method according to claim 1 in which the method includes a likelihood which includes a factor accounting for stutter and/or the method includes a likelihood which includes a factor accounting for allele dropout.

3. A method according to claim 2 in which the method includes an estimated probability density function for stutter heights conditional on the height of the parent allele.

4. A method according to claim 1 in which the method includes an estimated joint probability density function of peak height pairs conditional on DNA quantity.

5. A method according to claim 1 in which the method includes a latent variable X representing DNA quantity that models the variability of peak heights across the profile.

6. A method according to claim 1 in which the method includes a latent variable Δ that discounts DNA quantity according to a numerical representation of the molecular weight of the locus.

7. A method according to claim 1 in which the comparing considers a likelihood ratio which summarises the value of the evidence in providing support to a pair of competing propositions.

8. A method according to claim 1 in which the probability distribution function for the variation of the allele peak height for the allele with DNA quantity is obtained from experimental data.

9. A method according to claim 8 in which the probability distribution function is be modeled by a Gamma distribution, the Gamma distribution is specified through two parameters: the shape parameter α and the rate parameter β, and these shape parameters are further specified through two parameters: the mean height h̅, which models the mean value of the homozygote peaks, and parameter k that models the variability of peak heights for the given DNA quantity χ.

10. A method according to claim 1 in which the probability distribution function for the variation of the stutter peak height for an allele with the allele peak height for the allele which is one size unit greater is obtained from experimental data.

11. A method according to claim 10 in which the probability distribution function is provided by a Beta distribution describing the probabilistic behaviour of the stutter height from the allele height, the generic formula for the Beta distribution being:
$$f ( y \vert α , β ) = \frac{Γ ( α + β )}{Γ ( α ) Γ ( β )} {{y}^{α - 1} ( 1 - y )}^{β - 1}$$

12. A method according to claim 1 in which the results from the comparing provide information to assist further investigations or legal proceedings and/or to provide intelligence on a situation and/or to provide a likelihood of the information of the first or test sample result given the information of the second or another sample result, for instance a match therewith.

13. A method according to claim 1 in which the results from the comparing provide a link between a DNA profile, for instance from a crime scene sample, and one or more profiles, for instance one or more profiles stored in a database.
